(19) United States
(12) Patent Application Publication
(10) Pub. No.: US 2012/0059599 A1
(43) Pub. Date: Mar. 8, 2012

(54) HYBRID FRAGMENT-LIGAND MODELING FOR CLASSIFYING CHEMICAL COMPOUNDS

(75) Inventors: Albert Cunningham, Crestwood, KY (US); John O. Trent, Louisville, KY (US)

(73) Assignee: UNIVERSITY OF LOUISVILLE, Louisville, KY (US)

(21) Appl. No.: 13/224,915

(22) Filed: Sep. 2, 2011

Related U.S. Application Data
(60) Provisional application No. 61/380,048, filed on Sep. 3, 2010.

(51) Int. Cl. G06F 19/00; G06G 7/58

(52) U.S. Cl. 702/27; 703/12; 703/11

(57) ABSTRACT

A system and method generate a structure activity relationship model to determine whether unknown chemical compounds are of a desired classification where the structure activity relationship model is based on a set of known chemical compounds having known structural and/or biological descriptors. A system and method utilize a structure activity relationship model to determine whether unknown chemical compounds are of the desired classification, where descriptors of the known chemical compounds are compared to structural and/or biological descriptors of the unknown chemical compounds to determine whether the test chemical compounds are of the desired classification. A system and method generate a structure activity relationship model to study how particular agents may induce disease or act as therapeutic agents. The model may also be used to study how groups of agents induce disease or act as therapeutic agents and to study the etiology and treatment of disease in general.

### CROSS-REFERENCE TO RELATED APPLICATIONS

This application claims priority to U.S. Provisional Application Ser. No. 61/380,048 filed by Albert Cunningham and John Trent on Sep. 3, 2010, and entitled “HYBRID FRAGMENT-LIGAND MODELING FOR CLASSIFYING CHEMICAL COMPOUNDS,” which application is incorporated by reference in its entirety.

### GOVERNMENT RIGHTS

The invention was made with Government support under National Institutes of Health contract No. P20 RR018733. The Government has certain rights in the invention.

### FIELD OF THE INVENTION

The invention is generally related to modeling of chemical compounds for the purpose of classifying and/or predicting properties thereof.

### BACKGROUND OF THE INVENTION

The advent of structure-activity relationship (SAR) and quantitative SAR (QSAR) models has allowed for the prediction of toxicants and the rational design of therapeutic agents based on their similarity in chemical structure to previously tested compounds. Moreover, QSAR approaches have investigated sets of similarly shaped chemicals with discrete mechanisms of action, including binding to a specific binding site of a specific protein. However, chemical compounds associated with adverse human health effects are generally not amicable to traditional QSAR modeling due to the structural diversity of chemicals being modeled for these endpoints and also because no generalized mechanism of action is applicable to an entire set of compounds (e.g. a specific receptor site, a specific chemical fragment, indicative of an adverse human health effect).

Conventionally, classifying a chemical compound may require significant resources including time to conduct the assessment and the costs associated therewith. For example, a complete cancer bioassay conducted by the National Toxicology Program (NTP) for classifying a chemical compound may require approximately two years to perform and cost in the millions of dollars. To date, approximately 538 technical reports are available from the NTP for rodent carcinogenicity. In addition, analysis and data from 6540 experiments on 1547 chemicals are available from the Carcinogenic Potency Database (CPDB). However, there are approximately 75,000 industrial chemicals on the Toxic Substance Control Act's Chemical Substance Inventory, which indicates a need for accurate and cost and time efficient SAR models for use in classifying chemical compounds.

SAR models have been developed to efficiently and rapidly analyze large numbers of structurally diverse chemical compounds without the need for any generalized mechanism of action. For example, SAR models have been used for carcinogenesis, such as predicting mammary carcinogens, using data from the Carcinogenic Potency Database (CPDB). These models generally use chemical descriptors that describe fragments of chemical structures of model chemical compounds known to be carcinogenic or known to be non-carcinogenic. For example, some models compared rat mammary carcinogens and rat non-carcinogens to determine whether a test chemical compound is likely to be a mammary carcinogen or non-carcinogen based on the fragment descriptors present in the model. These conventional models have provided some predictive capability for classifying chemical compounds; however, the predictive results have been moderately accurate when compared to experimental results.

As discussed above, data corresponding to chemical compounds and classifications of the chemical compounds are available from some sources. For example, data from the CPDB indicates whether a known chemical compound is carcinogenic or not, where the classification typically was determined after time consuming and costly assessment of the chemical compound. While some SAR models have been generated which compare chemical composition fragments (known as “fragment descriptors”) of the previously classified chemical compounds to classify unknown chemical compounds, these SAR models have had limited success accurately classifying the wide variety of chemical compounds used in industrial, medical, domestic, and other such settings.

Therefore, a significant need continues to exist in the art for improved modeling systems and methods for classifying a chemical compound and/or predicting properties of a chemical compound.

### SUMMARY OF THE INVENTION

The invention addresses these and other problems associated with the prior art by using a hybrid modeling method and system that models not only the chemical structures of chemical compounds, e.g., using fragment descriptors, but also models biologically-relevant properties, and in particular chemical-protein interactions using “ligand descriptors” developed by virtual screening of compounds in a model's learning set, where the chemical compounds in the model's learning set have been previously classified, against a large and diverse set of proteins. Using data, including for example the carcinogenic classification of known chemical compounds, where the known chemical compounds comprise the model's learning set, a SAR model may be generated to determine classifications of unknown chemical compounds based on the known classifications from previous classification assessments and the resulting data.

In some embodiments of the invention, previously classified (i.e., “model”) chemical compounds are analyzed to determine ligand descriptors associated with each model chemical compound. The ligand descriptors associated with each model chemical compound indicate whether the model chemical compound may bind with a specific ligand binding cavity (a “binding site”) of a plurality of ligand binding sites. In some embodiments, each model chemical compound may be virtually screened against each ligand binding site, where the affinity of the model chemical compound to bind to the ligand binding site may be estimated based at least in part on hydrophobic, polar complementary, entropic, and/or solvation attributes. As such, each model chemical compound may include a plurality of ligand descriptors associated therewith, where each ligand descriptor indicates that the model chemical compound may interact with a specific ligand binding site.

In some embodiments of the invention, a computer based structure activity relationship model is generated. In these embodiments, a computer generating the computer based structure activity relationship model receives data corresponding to a plurality of model chemical compounds, where the data also indicates a plurality of ligand descriptors associated with each of the model chemical compounds. The computer generates the computer based structure activity relationship model based on the plurality of model chemical compounds and the plurality of ligand descriptors associated with each model chemical compound. In these embodiments, the computer based structure activity relationship model is configured to receive data corresponding to a test chemical compound and classify the test chemical compound based on the model chemical compounds and associated ligand descriptors.

In some embodiments, a computer executing a computer based SAR model determines whether a test chemical compound is of a desired classification, where the computer based SAR includes data corresponding to a plurality of model chemical compounds and the data may further indicate a plurality of ligand descriptors associated with each model chemical compound. In these embodiments, data corresponding to the test chemical compound may be input into the computer based SAR model, and the computer based SAR model determines whether the test chemical compound is of the desired classification based at least in part on the model chemical compounds and ligand descriptors associated with each model chemical compound.

For example, in some embodiments, the computer based SAR may be configured to determine whether a test chemical compound is carcinogenic. In this example, the computer based SAR model may include a plurality of carcinogenic model chemical compounds and a plurality of ligand descriptors associated with each carcinogenic model chemical compound, and the computer based SAR model may also include a plurality of non-carcinogenic model chemical compounds and a plurality of ligand descriptors associated with each non-carcinogenic model chemical compound. Data corresponding to the test chemical compound may be input into the computer based SAR, and the computer based SAR may determine if the test chemical compound is carcinogenic.

### BRIEF DESCRIPTION OF THE DRAWINGS

The accompanying drawings, which are incorporated in and constitute a part of this specification, illustrate embodiments of the invention and, together with a general description of the invention given above and the detailed description given below, serve to explain the principles of the invention.

FIG. 1 is a diagrammatic illustration of a computer configured to execute a computer based structure activity relationship model to perform elements consistent with embodiments of the invention;

FIG. 2 is a block diagram illustrating an exemplary implementation of the computer based structure activity relationship model referenced in FIG. 1;

FIG. 3 is a flowchart illustrating a sequence of operations executable by a processor of the computer of FIG. 1 to thereby cause the processor to perform the steps necessary to generate a computer based structure activity relationship model consistent with embodiments of the invention;

FIG. 4 is a flowchart illustrating a sequence of operations executable by a processor of the computer of FIG. 1 to thereby cause the processor to perform the steps necessary to utilize a computer based structure activity relationship model consistent with embodiments of the invention to classify an unknown chemical compound;

FIG. 5 is a flowchart illustrating a sequence of operations executable by a processor of the computer of FIG. 1 to thereby cause the processor to perform the steps necessary to analyze a chemical compound to determine ligand binding descriptors associated with the analyzed chemical compound consistent with embodiments of the invention;

FIG. 6 is a flowchart illustrating a sequence of operations executable by a processor of the computer of FIG. 1 to thereby cause the processor to perform the steps necessary to analyze a chemical compound to determine fragment descriptors associated with the analyzed chemical compound consistent with embodiments of the invention;

FIG. 7 is a flowchart illustrating a sequence of operations executable by a processor of the computer of FIG. 1 to thereby cause the processor to classify a test chemical compound as DNA reactive, and dynamically select a model to execute to classify the test chemical compound based at least in part on whether the test chemical compound is DNA reactive consistent with embodiments of the invention;

FIG. 8 is a flowchart illustrating a sequence of operations executable by a processor of the computer of FIG. 1 to thereby cause the processor to perform the steps necessary to determine whether a test chemical compound is carcinogenic and in response to determining that the test chemical compound is carcinogenic, determine a target site at which the carcinogenic test chemical compound may interact to cause cancer consistent with embodiments of the invention;

FIG. 9 is a flowchart illustrating a sequence of operations executable by a processor of the computer of FIG. 1 to thereby cause the processor to determine a probability of activity for a test compound and determine whether the test chemical compound is of the desired classification based at least in part on the determined probability of activity consistent with some embodiments of the invention;

FIG. 10 is a flowchart illustrating a sequence of operations executable by a processor of the computer of FIG. 1 to thereby cause the processor to validate a SAR model using a leave one out validation process consistent with some embodiments of the invention;

FIG. 11 is a flowchart illustrating a sequence of operations executable by a processor of the computer of FIG. 1 to thereby cause the processor to validate a SAR model using a leave many out validation process consistent with some embodiments of the invention;

FIG. 12 is a flowchart illustrating a sequence of operations executable by a processor of the computer of FIG. 1 to thereby cause the processor to generate a SAR model, validate the SAR model, and utilize the SAR model to determine whether a test chemical compound is of the desired classification consistent with some embodiments of the invention;

FIG. 13 is a flowchart illustrating a sequence of operations executable by a processor of the computer of FIG. 1 to thereby cause the processor to generate a SAR model, validate the SAR model, and utilize the SAR model to determine whether a test chemical compound is of the desired classification consistent with some embodiments of the invention; and

FIG. 14 is a flowchart illustrating a sequence of operations executable by a processor of the computer of FIG. 1 to thereby cause the processor to analyze a SAR model to identify characteristics of a desired classification modeled by the SAR model.

It should be understood that the appended drawings are not necessarily to scale, presenting a somewhat simplified representation of various preferred features illustrative of the basic principles of embodiments of the invention. The specific features consistent with embodiments of the invention disclosed herein, including, for example, specific dimensions, orientations, locations, sequences of operations and shapes of various illustrated components, will be determined in part by the particular intended application, use and/or environment. Certain features of the illustrated embodiments may have been enlarged or distorted relative to others to facilitate visualization and clear understanding.

### DETAILED DESCRIPTION OF THE INVENTION

Embodiments of the invention provide for methods and apparatus generally directed to generating a computer based structure activity relationship (SAR) model and/or classifying chemical compounds utilizing a computer based structure activity relationship (SAR) model. Particularly, the SAR model utilized for classification includes a plurality of descriptors associated with a plurality of model chemical compounds, and one or more test chemical compounds may be input into the SAR model to determine whether the one or more test chemical compounds are of a desired classification based at least in part on whether descriptors associated with each of the one or more test chemical compounds correspond to the descriptors associated with the model chemical compounds included in the SAR model.

While embodiments of the invention have been and may hereinafter be described as receiving a chemical compound and/or descriptors associated therewith, as is known in the relevant field, a computer may receive data representative of a chemical compound and/or descriptors associated therewith. For example, a test chemical compound and associated properties may be input into a computer based SAR model consistent with embodiments of the invention, and those skilled in the art will recognize such input may be in the form of data in a format recognized by the computer executing the computer based SAR model, such that the data indicates the chemical compound, ligand and/or fragment descriptors associated therewith, whether the chemical compound is of a desired classification and/or other such similar information. As such, in embodiments consistent with the invention, such data associated with a chemical compound may be input into and/or received by a computer based SAR model, such that the data associated with the chemical compound may be further utilized by the computer based SAR consistent with embodiments of the invention.

Moreover, in embodiments consistent with the invention, data associated with chemical compounds may be input and/or received from data storage sources connected locally and/or over a communication network, input/output (I/O) interfaces connected locally and/or over a communication network, and/or applications executing on processors of one or more computers connected locally and/or over a communication network. For example, as discussed above, the Carcinogenic Potency Database (CPDB), accessible at URL: http://potency.berkeley.edu includes such data associated with chemical compounds that may be input to and/or received by embodiments consistent with the invention. Other such sources include, for example, technical reports by the National Toxicology Program (NTP) (accessible at the NTP's website, URL: http://http://ntp.niehs.nih.gov), the Distributed Structure-Searchable Toxicity (DSSTox) Database Network (accessible at the U.S. Environmental Protection Agency's website, URL: http://http://www.epa.gov/ncct/dsstox/index.html), and/or similar data sources known in the relevant field.

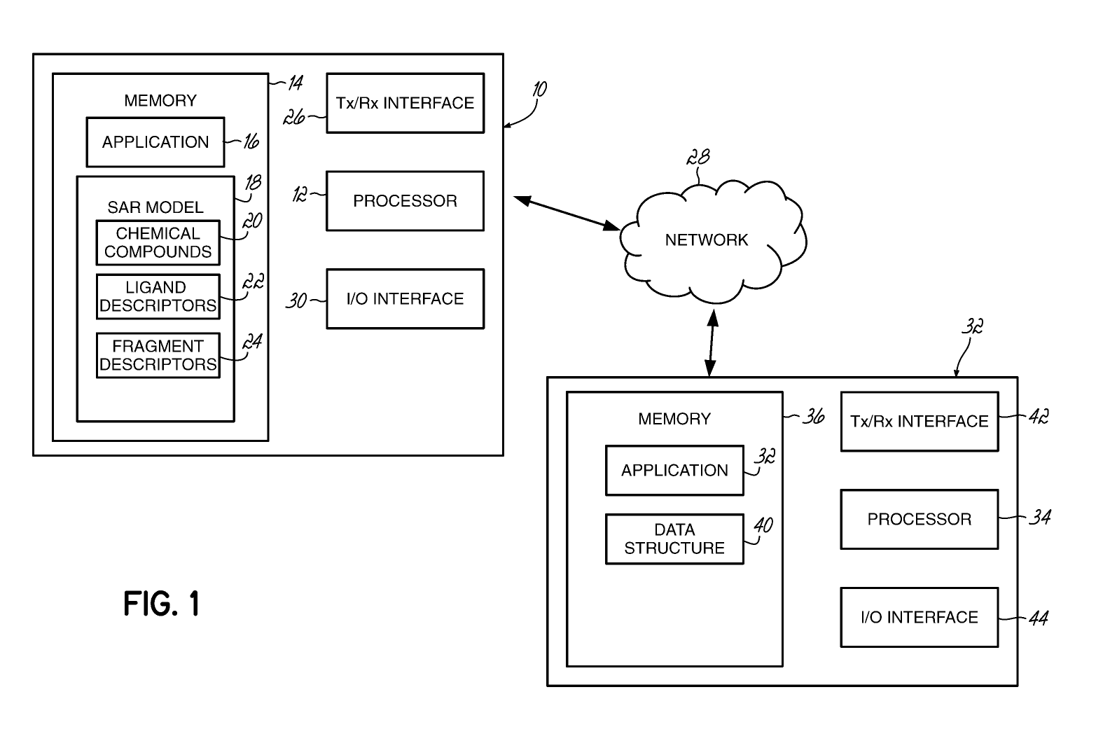

Turning to the drawings, wherein like numbers may denote like parts throughout the several views, FIG. 1 is a diagrammatic illustration of a computer 10 consistent with embodiments of the invention. As shown in FIG. 1, computer 10 includes a processor 12 and memory 14, where memory 14 may include application 16 stored thereon. As is generally known in the art, an application, including for example application 16, comprises routines, instructions, steps, operations, program code and the like configured to be executed by a processor, including for example processor 12, to cause the processor to perform the steps necessary to execute steps, elements, and/or blocks embodying the various aspects of embodiments of the invention. As such, in some embodiments, application 16 includes such instructions necessary to cause processor 12 to perform the elements of some embodiments of the invention.

Consistent with some embodiments of the invention, computer 10 may further include a computer based SAR model 18 stored in memory 14 and executable by processor 12, where SAR model includes data associated with one or more model chemical compounds 20, a plurality of ligand descriptors 22 associated with the model chemical compounds 20, and/or fragment descriptors 24 associated with the model chemical compounds 20. Moreover, computer based SAR model 18 may be configured to be executed by processor 12 to cause processor 12 to perform steps necessary to perform the steps necessary to execute steps, elements, and/or blocks embodying the various aspects of embodiments of the invention. Furthermore, computer 10 may include transceiver 26, where transceiver 26 may be configured to transmit and receive data to and from communication network 28 consistent with embodiments of the invention. In addition, computer 10 may include input/output interface (I/O interface) 30, where I/O interface 30 may be configured to transmit and receive data to and from attached devices, including for example, a computer keyboard, a computer mouse, a computer monitor, a printer, computer speakers, and other such human interface devices known in the art.

As shown in FIG. 1, computer 32 may be connected to communication network 28, such that computer 10 may communicate with computer 32. Computer 32 may include processor 34 and memory 36, where memory may include an application 38 and data structure 40. As discussed above, with regard to computer 10, application 38 may be similarly configured to cause processor 34 to perform operations consistent with embodiments of the invention. Furthermore, data structure 40 may store data associated with chemical compounds, where such data may indicate chemical structure of a chemical compound, classification of a chemical compound, descriptors associated with a chemical compound, and other such similar information. As such, in some embodiments data structure 40 may comprise one or more databases storing data associated with one or more chemical compounds for use in embodiments consistent with the invention. In addition, computer 32 may include Tx/Rx interface connected to communication network 28 and I/O interface 44 connected to one or more attached devices.

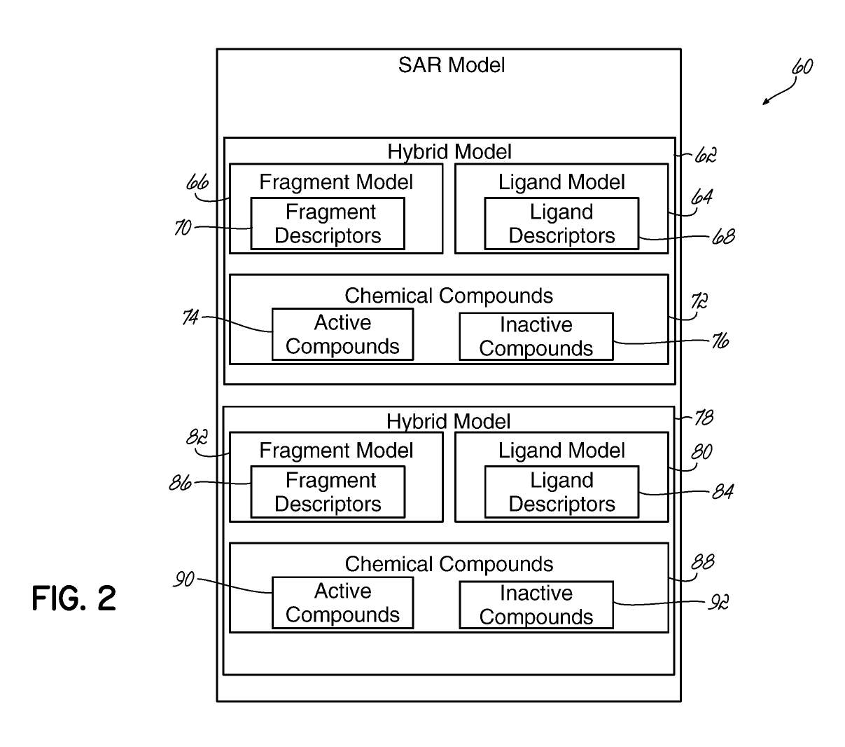

FIG. 2 is a block diagram illustrating a computer based SAR model 60 consistent with some embodiments of the invention. As shown in FIG. 2, SAR model 60 includes hybrid model 62 which may be considered a “hybrid” model because model 62 includes two different models which may be utilized individually and/or in combination to classify input unclassified/unknown (i.e., “test”) chemical compounds. In these embodiments, the hybrid model 62 includes a ligand model 64 and a fragment model 66. As shown, the ligand model 64 includes data indicating a plurality of ligand descriptors 68, and the fragment model 66 includes data indicating a plurality of fragment descriptors 70 where the descriptors 68, 70 are associated with previously classified chemical compounds included in the learning set of the hybrid model 62 (i.e., “model chemical compounds”), the model chemical compounds may be indicated by chemical compound data 72 of hybrid model 62. In addition, the chemical compound data 72 associated with the plurality of model chemical compounds may indicate whether the model chemical compounds are of a desired classification (i.e., “active” compounds) 74 and/or not of the desired classification (i.e., “inactive” compounds) 76. Referring to the hybrid model 62 included in SAR model 60, embodiments of the invention may input a test chemical compound into the SAR model 60, and the SAR model 60 may determine whether to apply the ligand model 64 and/or the fragment model 66 of hybrid model 62 to determine whether the test chemical compound is of the desired classification.

As shown in FIG. 2, SAR model 60 may include an additional model, which in this exemplary embodiment is hybrid model 78. Similar to hybrid model 62, hybrid model 78 may include ligand model 80 and fragment model 82, where ligand model 80 may include ligand descriptors 84, and fragment model 82 may include fragment descriptors 86. The descriptors 84, 86 may be associated with the model chemical compounds indicated by chemical compound data 88 included in hybrid model 78, where chemical compound data may further indicate which model chemical compounds of the plurality of model chemical compounds are active compounds 90 and which model chemical compounds of the plurality of model chemical compounds are inactive compounds 92.

Those skilled in the art will recognize that SAR model 60 of FIG. 2 is an exemplary block diagram of a computer based SAR model consistent with some embodiments of the invention, and the invention is not so limited. For example, a SAR model consistent with embodiments of the invention may include one or more models, including, for example, one or more hybrid models (e.g., each hybrid model includes two or more models which may be applied concurrently or individually, including for example one or more ligand models and/or one or more fragment models); the SAR model may include one model, including for example a ligand model and/or a fragment model; the SAR model may include a plurality of ligand models, fragment models, and/or hybrid models in various combinations. As such, SAR models consistent with embodiments of the invention may comprise a variety of configurations. For example, in some preferred embodiments, a SAR model may comprise a ligand model, where the ligand model includes a plurality of model chemical compounds (i.e., a learning set) and a plurality of ligand descriptors associated with each model chemical compound. Furthermore, a model included in a SAR model consistent with embodiments of the invention may be executed to determine whether a test chemical compound is of a desired classification; therefore, a SAR model comprising two or more models may be executed to determine whether a test chemical compound is of two or more desired classifications. In addition, in some embodiments, a SAR model consistent with some embodiments of the invention may dynamically select one or more models for execution based at least in part on a previous determination of whether a test chemical compound is of a desired classification, as will be discussed below in detail.

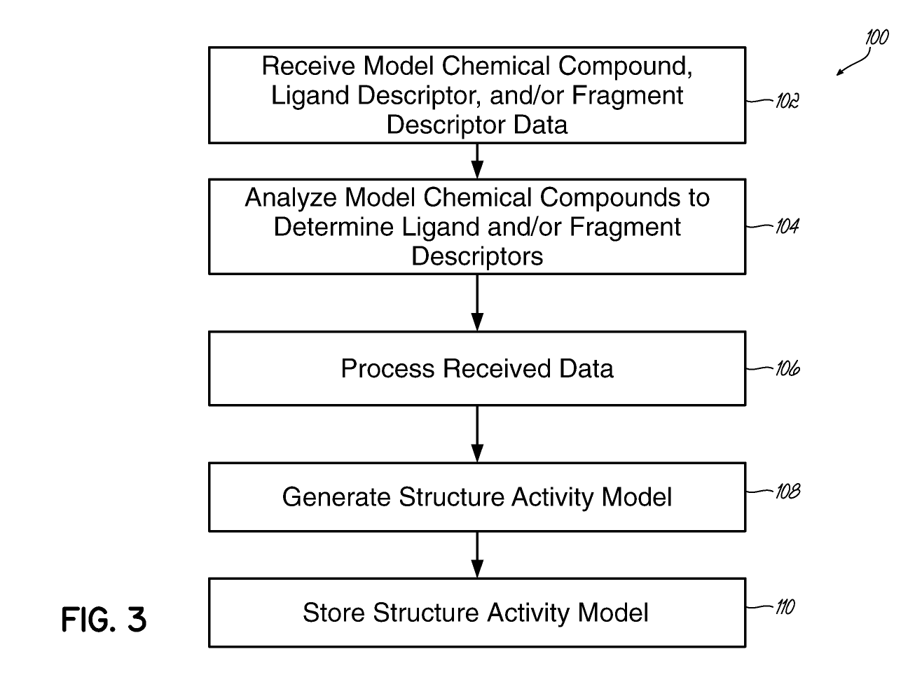

FIG. 3 provides flowchart 100 which illustrates a sequence of operations configured to be executed by a computer to generate a computer based SAR model consistent with embodiments of the invention. In embodiments consistent with the invention, a computer receives data associated with a plurality of model chemical compounds (block 102). The data may indicate each model chemical compound, whether or not each model chemical compound is of the desired classification, a plurality of ligand descriptors associated with each model chemical compound, and/or a plurality of fragment descriptors associated with each model chemical compound.

In some embodiments, the computer may analyze each model chemical compound of a plurality of model chemical compounds to determine a plurality of ligand descriptors and/or a plurality of fragment descriptors associated with each model chemical compound of the plurality (block 102). In these embodiments, the data received in block 102 may not indicate the plurality of ligand descriptors and/or the plurality of fragment descriptors associated with each model chemical compound. As such, in some embodiments, the computer based SAR model may advantageously analyze the model chemical compounds to determine the ligand descriptors and/or fragment descriptors associated with the model chemical compounds.

As discussed previously, a respective ligand descriptor associated with a respective chemical compound may indicate the propensity of the respective chemical compound to act as a ligand to a specific protein of a plurality of proteins; i.e., such respective ligand descriptor indicates that the respective chemical compound may bind with the specific protein at a binding site of the specific protein. As such, in some embodiments, each respective model chemical compound of the plurality of model chemical compounds may be virtually screened by a computer consistent with embodiments of the invention to determine whether the respective model chemical compound may bind with each binding site of each protein of the plurality of proteins. Virtual screening methods consistent with embodiments of the invention virtually dock a chemical compound a ligand binding site and determine whether the chemical compound may bind by estimating the affinity of the chemical compound to the binding site, where such estimation may be based at least in part on hydrophobic, polar complementarity, entropic, enthalpic, electrostatic, shape, fragment, trained scoring algorithms, alternate scoring algorithms, calculated properties and solvation attributes. Therefore, based on the virtual screening, a plurality of ligand binding sites may be determined for each model chemical compound of the plurality of model chemical compounds. Virtual screening consistent with some embodiments of the invention may be performed by one or more applications accessing databases storing information related to protein binding sites, including for example, the Protein Data-Bank (“PDB”) and the screening-PDB database (sc-PDB) (accessible at url: http://bioinfo-pharma.u-strasbg.fr/scPDB). Based at least in part on the ligand binding sites determined for each model chemical compound, a plurality of ligand descriptors may be associated with each model chemical compound. Furthermore, those skilled in the art will recognize that various virtual screening software applications may be used to analyze compounds to determine a ligand binding site, including, for example, AutoDock, EADock, Surflex-Dock, and/or other such software applications.

In some embodiments, a computer may analyze the model chemical compounds to determine fragment descriptors associated with the model chemical compound. In these embodiments, each model chemical compound is fragmented into all possible fragments based at least in part on atom type, bond type and atomic connections. In these embodiments, a computer may fragment a respective model chemical compound by analyzing the two-dimensional chemical structure of the compound and identifying fragments based on the properties of the two-dimensional chemical structure, such as atom type, bond type and atomic connections. Based at least in part on the identified chemical fragments determined for each model chemical compound, a plurality of fragment descriptors may be associated with each model chemical compound.

The computer processes the data (block 106), where processing may include for example, analyzing the data to determine which model chemical compounds of the plurality are of the desired classification and which model chemical compounds of the plurality are not of the desired classification.

The computer generates a computer based SAR model based at least in part on the model chemical compounds, the desired classification, the associated ligand descriptors, and/or the associated fragment descriptors (block 108). The computer based SAR model may be stored in a memory of the computer or in a memory remotely connected to the computer including, for example, a memory of another computer, server, or other such device (block 110). The computer based SAR model may be configured to receive data associated with one or more test chemical compounds, where the data may indicate the test chemical compound, associated ligand descriptors, and/or associated fragment descriptors. Furthermore, the computer based SAR model may be configured to classify the input test chemical compound based at least in part on the model chemical compounds, the classification of each model chemical compound of the plurality, associated ligand descriptors, and/or associated fragment descriptors. Additionally, in some embodiments, the computer based SAR model may be configured to analyze the input test chemical compound to determine ligand descriptors and/or fragment descriptors associated with the input test chemical compound, similar to the methods described above with respect to analyzing the model chemical compounds to determine ligand descriptors and fragment descriptors. As those skilled in the art will recognize, the computer based SAR model may be generated using specially configured software environments, or alternatively, the computer based SAR model may be generated utilizing for example, cat-SAR (as described in: Development of an information-intensive structure-activity relationship model and its application to human respiratory chemical sensitizers, Cunningham, A. R. et al (2005)). It will be appreciated, however, that other software environments and/or utilities may be utilized to implement embodiments consistent with the invention.

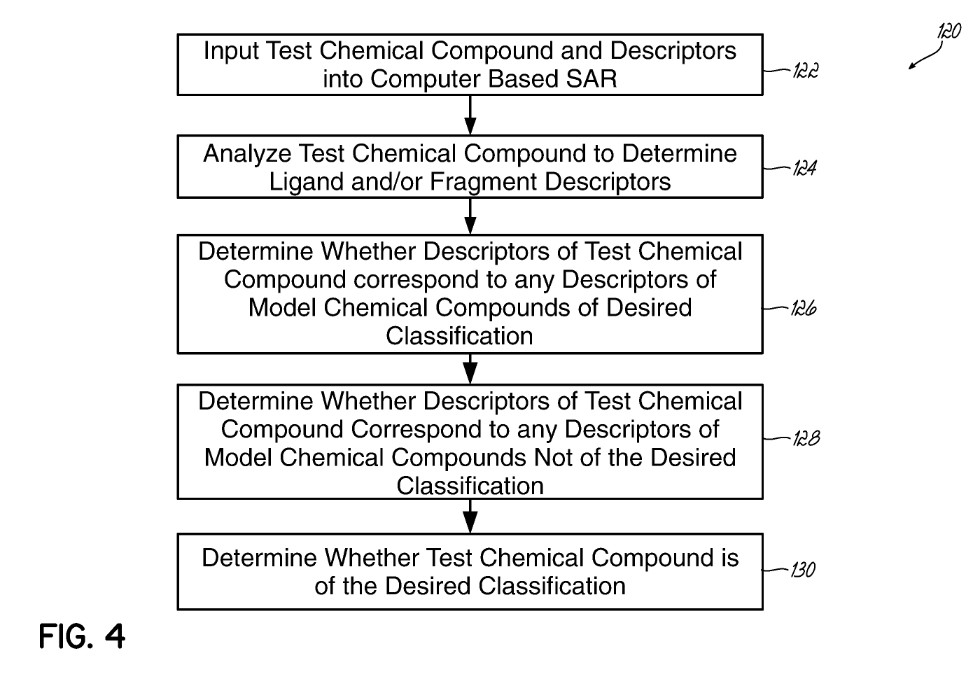

FIG. 4 provides flowchart 120, which illustrates a sequence of operations that may be performed by a computer executing a computer based SAR model consistent with some embodiments of the invention to cause a processor of the computer to determine whether a test chemical compound is of a desired classification. In some embodiments, data associated with a test chemical compound may be input into a computer based SAR model executing on a computer consistent with embodiments of the invention (block 122). Consistent with embodiments of the invention, the data may indicate the test chemical compound, ligand descriptors, and/or fragment descriptors associated with the test chemical compound. In some embodiments, particularly those embodiments in which the data does not indicate ligand descriptors and/or fragment descriptors associated with the test chemical compound, the computer based SAR model may analyze the test chemical compound to determine the ligand descriptors and/or fragment descriptors associated with the test chemical compound (block 124). As discussed above with respect to block 104 of FIG. 1, similarly, ligand descriptors associated with the test chemical compound may be determined by virtually screening the test chemical compound to determine a plurality of binding sites at which the test chemical compound may bind. Likewise, fragment descriptors associated with the test chemical compound may be determined by fragmenting the test chemical compound.

The computer based SAR model determines whether descriptors associated with the test chemical compound correspond to any descriptors associated with model chemical compounds of the desired classification (i.e., “active” model chemical compounds) (block 126). As such, in some embodiments, the computer based SAR model may determine whether the ligand descriptors associated with the test chemical compound matches any ligand descriptors associated with the active model chemical compounds. Additionally, the SAR model may determine whether the fragment descriptors associated with the test chemical compound matches any fragment descriptors associated with the active model chemical compounds. As such, the SAR model may determine one or more ligand and/or fragment descriptor matches between the test chemical compound and the active model chemical compounds, where each such “active” match increases the likelihood that the test chemical compound is also of the desired classification.

The computer based SAR model determines whether descriptors associated with the test chemical compound correspond to any descriptors associated with model chemical compounds not of the desired classification (i.e., “inactive” model chemical compounds) (block 128). As such, in some embodiments, the SAR model may determine whether the ligand descriptors associated with the test chemical compound matches any ligand descriptors associated with the inactive model chemical compounds. Additionally, the SAR model may determine whether the fragment descriptors associated with the test chemical compound matches any fragment descriptors associated with inactive model chemical compounds. As such, the SAR model may determine one or more ligand and/or fragment descriptor matches between the test chemical compound and the inactive model chemical compounds, where each such “inactive” match decreases the likelihood that the test chemical compound is also of the desired classification.

Based at least in part on the determined active matches and inactive matches, the SAR model determines whether the test chemical compound is of the desired classification (block 130). Therefore, in these embodiments, the computer generated SAR model may be utilized to determine whether the test chemical compound is of a desired classification, where the computer generated SAR model includes active model chemical compounds, inactive model chemical compounds, ligand descriptors associated with the model chemical compounds, and/or fragment descriptors associated with the model chemical compounds.

For example, a computer based SAR model consistent with embodiments of the invention may be configured to determine whether a test chemical compound is carcinogenic. In this exemplary embodiment, the computer based SAR model may include a plurality of model chemical compounds classified as carcinogenic (i.e., active model chemical compounds) and a plurality of model chemical compounds classified as non-carcinogenic (i.e., inactive model chemical compounds). The computer based SAR model may further include a plurality of ligand descriptors and/or fragment descriptors associated with the plurality of model chemical compounds. The test chemical compound may be input into the SAR model to determine whether the test chemical compound is carcinogenic. In this example, the ligand and/or fragment descriptors associated with the test chemical compound may be determined by analyzing the test chemical compound, as discussed above, or alternatively, the ligand and/or fragment descriptors associated with the test chemical compound may be indicated by the input data. The SAR model analyzes the test chemical compound to determine active matches and inactive matches, as described above, and based at least in part on the determined active matches and the inactive matches, the SAR model determines whether the test chemical compound is carcinogenic.

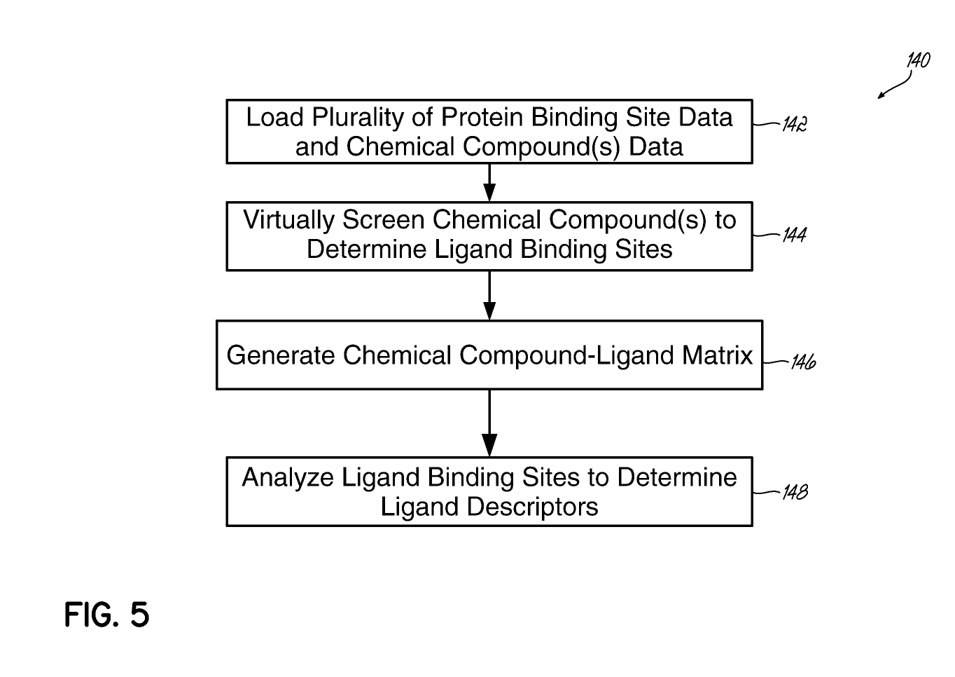

FIG. 5 provides flowchart 140, which illustrates a sequence of operations that may be performed by a computer executing and/or generating a computer based SAR model consistent with some embodiments of the invention to analyze a chemical compound and determine a plurality of ligand descriptors to associate with the chemical compound. In these embodiments, data associated with a plurality of proteins may be loaded, where the data may indicate one or more ligand binding sites associated with each protein of the plurality of proteins. Data associated with a chemical compound may be loaded, where the data may indicate the chemical compound (block 142). The computer may virtually screen the chemical compound to determine whether the chemical compound may bind with each ligand binding site associated with a protein of the plurality of proteins (block 144). For example, using sc-PDB, a chemical compound may be virtually screened against more than 5,000 ligand binding sites, where each ligand binding site is associated with a protein of the plurality of proteins. An affinity of chemical compound for each ligand binding site is estimated based at least in part on the hydrophobic, polar complementarity, entropic, and/or salvation terms. For the chemical compound, an affinity score based on the estimated affinity may be determined for the chemical compound for each ligand binding site, where the a high score indicates that the chemical compound may be a ligand for the protein associated with the ligand binding site.

As discussed above, in some embodiments, the SAR model may analyze the model chemical compounds to determine ligand descriptors associated with each model chemical compound. As such, in some embodiments, the computer executing the SAR model may generate a chemical compound-ligand matrix, where each row of the matrix may represent a model chemical compound of the plurality, and each column may represent a protein of the plurality of proteins (block 146).

The computer may analyze the affinity scores for each ligand binding site to determine a plurality of ligand descriptors associated with each model chemical compound (block 148). For a respective model chemical compound, the computer may determine a subset of the plurality of proteins with which the respective model chemical compound is most likely to interact based at least in part on the affinity score determined for the respective model chemical compound for the ligand binding site associated with each protein of the plurality, and the computer may associate ligand descriptors to each model chemical compound based at least in part on the determined subset of proteins for each model chemical compound.

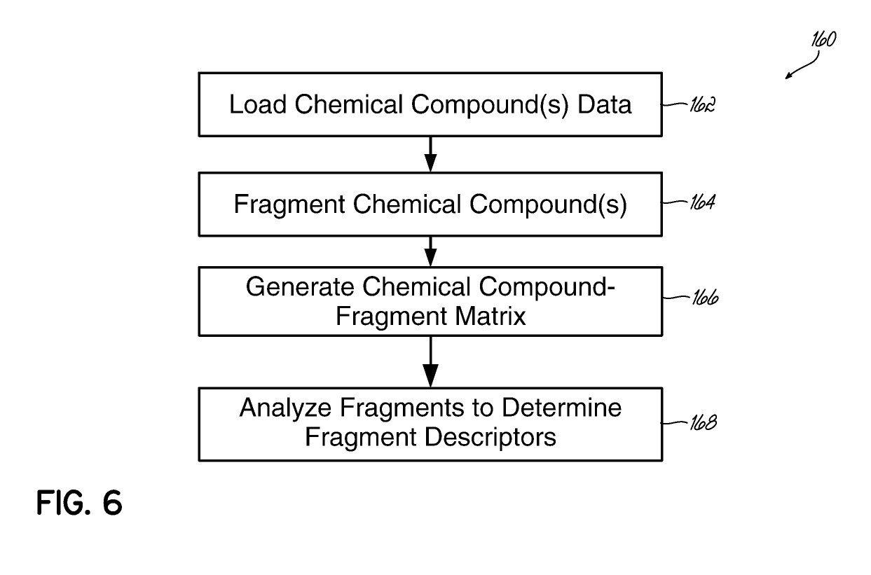

FIG. 6 provides flowchart 160, which illustrates a sequence of operations that may be performed by a computer executing and/or generating a computer based SAR model to analyze a chemical compound and determine a plurality of fragment descriptors to be associated with the chemical compound consistent with embodiments of the invention. As shown in flowchart 160, a computer consistent with some embodiments of the invention may load data associated with a chemical compound (block 162). The computer may fragment the chemical compound based at least in part on the two-dimensional chemical structure of the chemical compound, the atom type, the bond type, and/or atomic connections, such that chemical fragments of the chemical compound may be determined (block 164).

In some embodiments, a plurality of model chemical compounds may be analyzed to determine a plurality of fragment descriptors associated with each model chemical compound. In these embodiments, a computer may generate a chemical compound-fragment matrix where each row of the matrix may represent a model chemical compound of the plurality, and the columns may comprise the fragments of the chemical compound (block 166). The computer may analyze the fragments of each model chemical compound to determine the plurality of fragment descriptors to associate with each model chemical compound (block 168).

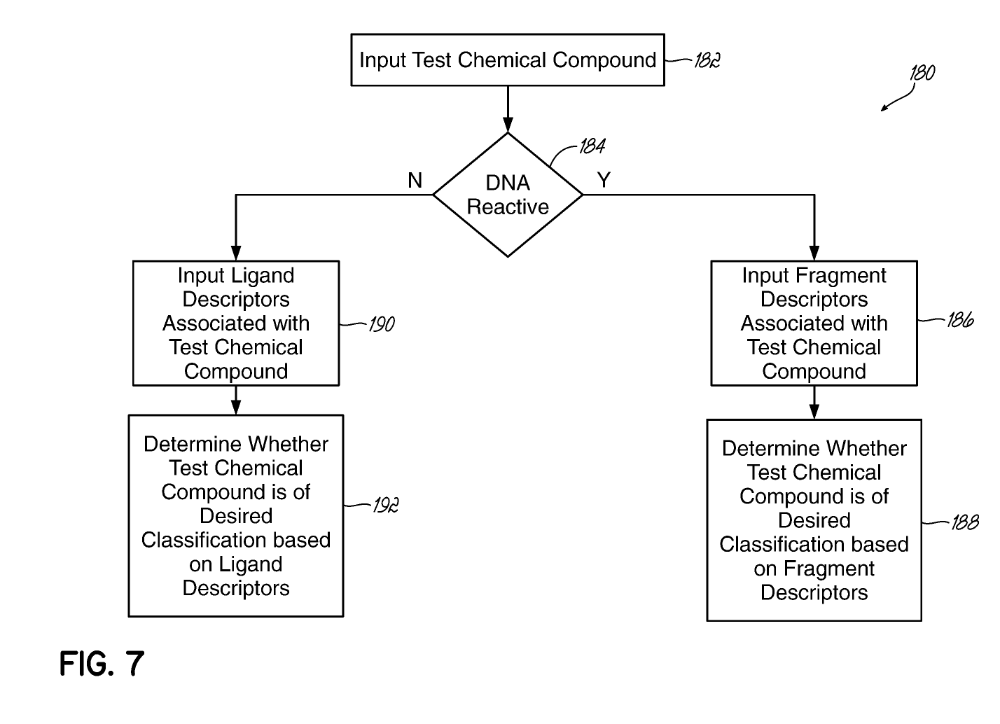

Referring now to FIG. 7, which provides flowchart 180, where flowchart 180 illustrates a sequence of operations that may be performed by a computer executing a computer based SAR model to determine whether an input test chemical compound is DNA reactive, and based at least in part on determining whether the test chemical compound is DNA reactive, dynamically selecting a SAR model to determine whether the test chemical compound is carcinogenic consistent with some embodiments of the invention. With respect to flowchart 180, and a computer based SAR model configured to be executed to carry out the operations of flowchart 180, the SAR model determines whether to determine whether a test chemical compound is of the desired classification using a ligand model or a fragment model included in the SAR model based at least in part on whether the test chemical compound is DNA reactive. Hence, in these embodiments, a test chemical compound may be input into a computer executing a SAR model consistent with embodiments of the invention (block 182).

The SAR model may determine whether the input test chemical is DNA reactive (block 184). In these embodiments, the SAR model may include a plurality of model chemical compounds and ligand and/or fragment descriptors which may be utilized to determine whether the test chemical compound is DNA reactive (e.g., the desired classification is DNA reactive), as discussed previously. As such, in these embodiments, the computer based SAR model may determine a first classification of the test chemical compound and dynamically determine an appropriate SAR model to execute to determine a second classification of the test chemical compound based at least in part on the first classification. Furthermore, the SAR model may make a plurality of classifications based at least in part on previous classifications. As such, the SAR model may include a plurality of model chemical compounds, a plurality of ligand descriptors, and/or a plurality of fragment descriptors which may be utilized for the first classification, and the SAR model may include a plurality of model chemical compounds, a plurality of ligand descriptors and/or a plurality of fragment descriptors which may be utilized for each successive classification. As such, referring to flowchart 180, the SAR model may include a first plurality of model chemical compounds, a first plurality of ligand descriptors, and/or a first plurality of ligand descriptors for determining whether the test chemical compound is DNA reactive, where the SAR model may analyze the test chemical compound using a ligand model and/or a fragment model of the SAR model based on the DNA reactivity classification.

In response to determining that the test chemical compound is DNA reactive (block 184, “Y” branch), the computer based SAR model may cause a fragment model included in the SAR model to be executed by inputting fragment descriptors associated with the test chemical compound into the fragment model of the SAR model (block 186). The SAR model determines whether the test chemical compound is of the desired classification based at least in part on the fragment descriptors associated with the test compound (block 188).

In response to determining that the test chemical compound is not DNA reactive (block 184, “N” branch), the computer based SAR model may cause a ligand model included in the SAR model to be executed by inputting ligand descriptors associated with the test chemical compound into the ligand model of the SAR model (block 190). The SAR model determines whether the test chemical compound is of the desired classification based at least in part on the ligand descriptors associated with the test chemical compound (block 192).

In these embodiments, a SAR model consistent with embodiments of the invention determines a first classification of the input test chemical compound, in response to the first classification, the SAR model may choose a particular model included in the SAR model to execute to make a second classification of the test chemical compound. While flowchart 180 illustrates a SAR model determining whether the test chemical compound is DNA reactive as the first classification, the invention is not so limited. For example, a SAR model consistent with embodiments of the invention may determine whether an input test chemical compound is carcinogenic, in response to determining whether the test chemical compound is carcinogenic, the SAR model may determine the target site/organ that the carcinogenic test chemical compound may cause cancer. Alternatively, in an exemplary embodiments, a SAR model consistent with the invention may determine whether a test chemical compound is DNA reactive; based at least in part on determining that the test chemical compound is or is not DNA reactive, the SAR model may execute a model included in the SAR model to determine whether the test chemical compound is carcinogenic; and based at least in part on determining whether the test chemical compound is carcinogenic, the SAR model may execute a model included in the SAR model to determine a target site/organ which the carcinogenic test compound interacts to cause cancer.

Embodiments consistent with the invention may determine whether unknown/unclassified test chemical compounds are of a desired classification and/or include a desired property, where such classifications include, for example, DNA reactivity, carcinogenicity, target organ/site where cancer may be caused, genotoxicity, mutagenicity, activity in target types of cells (e.g., a chemical compound may be active only in cancer cells of a specific type, and thus may be utilized to develop cancer treatment), and other such like classifications/properties.

Moreover, in embodiments similar to the exemplary embodiment provided in flowchart 180, by dynamically selecting a model included in the SAR model for execution based at least in part on a first classification, the SAR model may advantageously execute a particular model that is more effective at determining a second classification of the test chemical compound if the test chemical compound is of a first desired classification. For example, a fragment model included in the SAR model may be more effective at determining whether a test chemical compound is carcinogenic if the test chemical compound is DNA reactive. Likewise, a ligand model included in the SAR model may be more effective at determining whether a test chemical compound is carcinogenic if the test chemical compound is not DNA reactive. As such, embodiments of the invention may dynamically select different models included in the SAR model for execution to increase accuracy of classifications (as compared to classifications based on testing), effectiveness of the classifications, speed of the classification, and/or other like metrics.

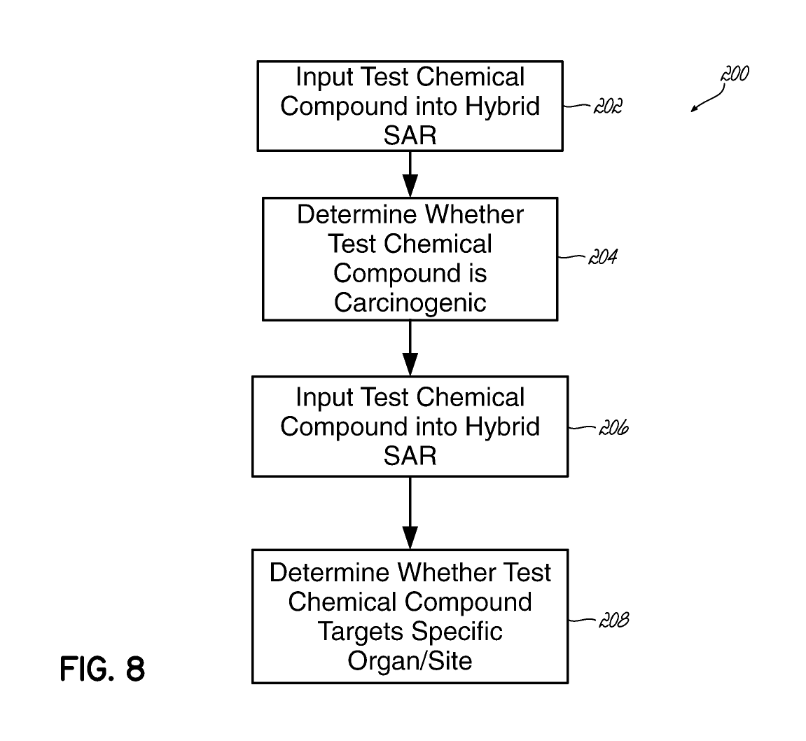

FIG. 8 provides flowchart 200, which illustrates a sequence of operations that may be performed by a computer executing a computer based SAR model consistent with some embodiments of the invention to determine whether a test chemical compound is carcinogenic, and in response to determining that the test chemical compound is carcinogenic, determine a target site/organ at which the test chemical compound is likely to interact to cause cancer. Similar to embodiments consistent with FIG. 7, embodiments consistent with FIG. 8 apply a plurality of models included in a SAR model consistent with embodiments of the invention to determine whether a test chemical compound is of a plurality of classifications. The test chemical is input into the SAR model (block 202).

The SAR model determines whether the test chemical compound is carcinogenic (block 204). As discussed, in some embodiments the SAR model may execute an included model to determine whether the test chemical compound is carcinogenic. Alternatively, in other embodiments, the data input into the SAR model may indicate that the test chemical compound is carcinogenic. In response to determining that the test chemical compound is carcinogenic, the test chemical compound is input into a model included in the SAR model (block 206). The SAR model determines whether the test chemical compound targets a specific site/organ to cause cancer (block 208). For example, the SAR model may determine whether the carcinogenic test chemical compound interacts to cause mammary cancer (i.e., the test chemical compound is a mammary carcinogen). Moreover, the SAR model may input the carcinogenic test chemical compound into a plurality of models to determine whether the carcinogenic test chemical compound interacts with a respective specific site/organ of a plurality of specific sites/organs, where a model for each respective site/organ may be included in the SAR model, consistent with some embodiments of the invention.

Furthermore, while in some embodiments a SAR model consistent with embodiments of the invention may determine a first classification using a model included in the SAR model, those skilled in the art will recognize that other classification methods and systems may be utilized to make a first classification, the results of which may be input into the SAR model for further classification. Moreover, while the invention has and hereinafter will be described as inputting a test chemical compound, those skilled in the art will recognize that a computer based SAR model consistent with embodiments of the invention may input a plurality of test chemical compounds, such that the SAR model may determine whether each test chemical compound of the plurality of input test chemical compounds are of the desired classification substantially in parallel.

FIGS. 3-14 provide flowcharts 100, 120, 140, 160, 180, 200, 220, 240, 260, 280, 300 and 320 which illustrate various embodiments of the invention, and while these embodiments have been described in considerable detail, the applicant does not intend to restrict or in any way limit the scope of the appended claims to such detail. For example, blocks of any of the flowcharts may be re-ordered, processed serially and/or processed concurrently without departing from the scope of the invention. Moreover, any of the flowcharts may include more or fewer blocks than those illustrated consistent with embodiments of the invention.

Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to carry out the distribution. Examples of computer readable media include but are not limited to tangible, recordable type media such as volatile and non-volatile memory devices, floppy and other removable disks, hard disk drives, magnetic tape, optical disks (e.g., CD-ROMs, DVDs, BLURAY, etc.), among others. Moreover, those skilled in the art will recognize that such computer readable media may include remotely connected memory locations.

As described above, SAR models consistent with embodiments of the invention execute to determine whether a test chemical compound is of a desired classification. Ligand and/or fragment descriptors are utilized to determine an association between the activity/inactivity of a test chemical compound, where “activity” may be defined as the test chemical compound being of the desired classification, and “inactivity” may be defined as the test chemical compound not being of the desired classification. The activity or inactivity of a descriptor may be determined based on the model chemical compounds with which the descriptor is associated. For example, a respective ligand descriptor may be associated with one or more model chemical compounds of the plurality, where some of the model chemical compounds may be active and some of the model chemical compounds may be inactive. However, not all ligand binding sites and chemical fragments determined from analysis of the model chemical compounds may be indicative of the activity or inactivity of the model chemical compound. Thus, in some embodiments of the invention, determining ligand descriptors and fragment descriptors by analyzing the model chemical compounds may include determining which ligand binding sites and which chemical fragments are important in the classification performed by the SAR model, and identifying those determined ligand binding sites and chemical fragments as descriptors for the model.

For example, in some embodiments a computer generating a SAR model consistent with embodiments of the invention may determine important ligand binding sites by requiring a threshold number of model chemical compounds to be a ligand for the protein associated with the ligand binding site. Likewise, in some embodiments, a computer generating a SAR model may require a threshold proportion of active model compounds and/or inactive model compounds to be a ligand for the protein associated with the ligand binding site. Similarly, in some embodiments a computer generating a SAR model consistent with embodiments of the invention may require a threshold number of model chemical compounds to include a particular chemical fragment, and/or the computer may require a threshold proportion of active model chemical compounds and/or inactive model chemical compounds to include the particular chemical fragment for the chemical fragment to be considered a fragment descriptor.

Furthermore, as discussed above, a respective descriptor may be associated with more than one model chemical drug, where a descriptor may be associated with one or more active model chemical compounds and one or more inactive model chemical compounds. As such, presence of a particular descriptor in the plurality of descriptors associated with a test chemical compound indicates a probability of inactivity and/or inactivity. As such, in some embodiments, after determining all ligand descriptors and/or fragment descriptors associated with the test chemical compound, the probability of activity (i.e., the probability that the test chemical compound is of the desired classification) must be determined, where a threshold probability of activity may be required by a SAR model consistent with embodiments of the invention to determine that the test chemical compound is of the desired classification.

SAR models consistent with embodiments of the invention may determine the probability of activity based at least in part on the number of active descriptor matches (i.e., a descriptor associated with the test chemical compound matches a descriptor associated with the active model chemical compounds) and/or the number of inactive descriptor matches (i.e., a descriptor associated with the test chemical compound matches a descriptor associated with the inactive model chemical compounds). For example in some embodiments, all active and inactive model chemical compounds associated with each descriptor may be added, and the total active model chemical compounds are divided by the total model chemical compounds to determine the probability of activity. For example, if two descriptors are associated with a test chemical compound, one descriptor being associated with 9/10 active model chemical compounds and the other descriptor being found in 3/3 inactive model chemical compounds, the probability of activity of the test chemical compound may be determined as 9/10 actives+0/3 actives=9/13 actives or a 69% chance of activity. In some embodiments, the probability of activity may be determined by calculating the probability of activity associated with each descriptor. Using the above example, the two probabilities of activity would be 90% (9/10 actives) and 0% (0/3 active), which may be averaged to determine a probability of activity of 45%.

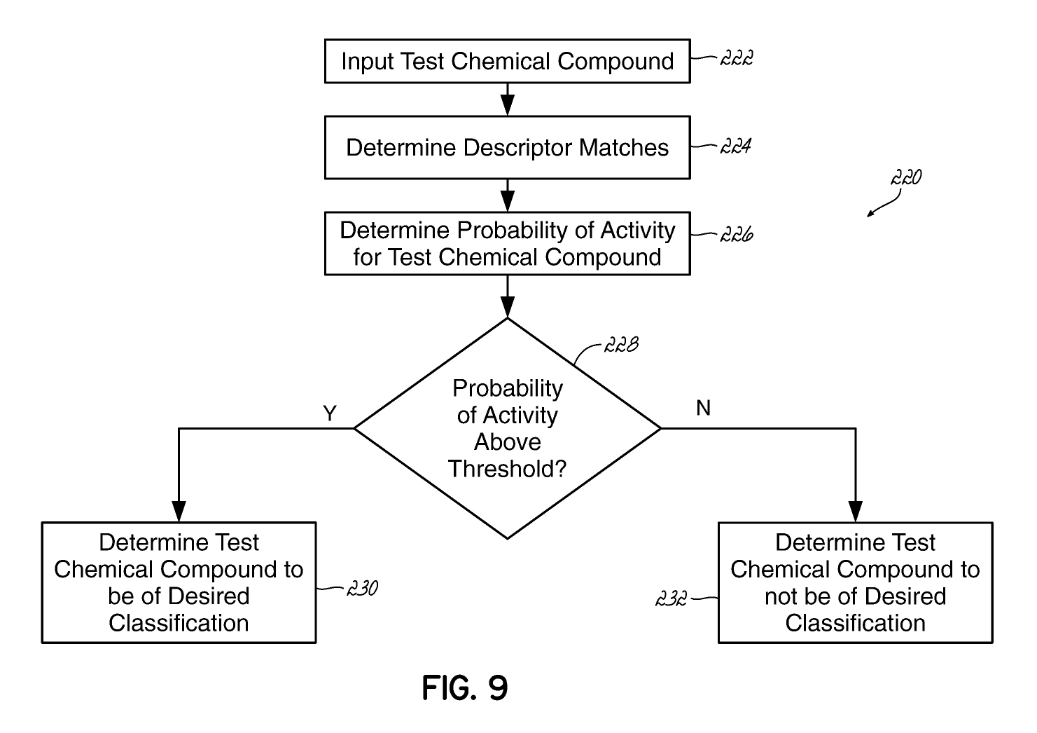

Referring to FIG. 9, which provides flowchart 220, where flowchart 220 illustrates a sequence of operations that may be performed by a computer executing a computer based SAR consistent with embodiments of the invention to determine whether a test chemical compound is of a desired classification. In embodiments consistent with the invention, a test chemical compound is input into a computer executing a computer based SAR model (block 222). As described previously, the test chemical compound is analyzed using the SAR model to determine fragment and/or ligand descriptors associated with the test chemical compound that correspond to fragment and/or ligand descriptors associated with the model chemical compounds, i.e., the SAR model determines descriptor matches between the test chemical compound and the model chemical compounds (block 224). A processor of the computer executing the SAR model determines the probability of activity (“activity value”) for the test chemical compound based on the determined descriptor matches (block 226). The computer determines whether the determined probability of activity is above a threshold value (“activity threshold”) (block 228). In response to determining that the probability of activity of the test chemical compound meets the activity threshold, the SAR model determines that the test chemical compound is of the desired classification (block 230). In response to determining that the probability of activity of the test chemical compound is below the activity threshold, the SAR model determines that the test chemical compound is not of the desired classification (block 232). As such, in these embodiments, an input test chemical compound may be determined to be of a desired classification based on the determined probability of activity.

In some embodiments consistent with the invention, a SAR model including a hybrid model, which in turn includes a ligand model and a fragment model, may execute both models to determine whether a test chemical compound is of the desired classification. As such, in some hybrid models consistent with SAR models of the invention, a determination of whether a test chemical compound is of the desired classification may require both the ligand model and the fragment model to determine that the test chemical compound is of the desired classification. In other embodiments consistent with the invention, a Bayesian hybrid model may combine determinations from the fragment model and the ligand model with a final determination as to classification based on Bayes' theorem.

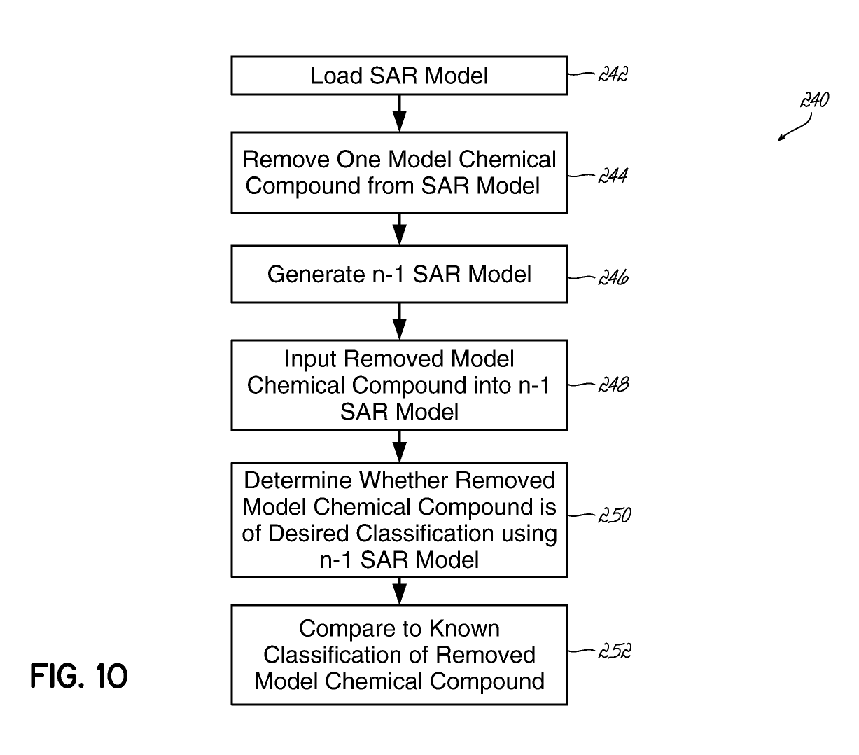

In some embodiments, a self-fit analysis, cross-validation analysis, and/or external validation may be performed by a computer generating a SAR model consistent with embodiments of the invention to determine whether generated SAR model accurately determines whether a chemical compound is of a desired classification. For a self-fit analysis, after a SAR model is developed, the SAR model may be used to predict the activity (and classification) of the model chemical compounds in order to ascertain whether or not the SAR model may be capable of at fitting its own data. In some embodiments, a leave-one-out (LOO) validation may be conducted where each model chemical compound, one at a time, may be removed from the plurality of model chemical compounds of the SAR model (i.e., the learning set of the SAR model) and an n-1 SAR model may be derived. Referring to FIG. 10, which provides flowchart 240, which provides a sequence of operations that may be performed by a computer generating a SAR model to perform a LOO validation. In these embodiments, the activity (i.e., classification) of the removed model chemical compound may be determined using the n-1 model. The computer loads a SAR model to be validated (block 242). A respective model chemical compound from the included plurality of model chemical compounds (i.e., the learning set) may be removed from the SAR model (block 244). Following removal of the respective model chemical compound from the learning set, the computer generates a SAR model not including the respective model chemical compound in the learning set, i.e., the computer generates an n-1 SAR model (block 246). The respective model chemical compound may be input into the executing n-1 SAR model to determine the predicted classification of the respective model chemical compound using the n-1 SAR model (block 248). The n-1 SAR model determines whether the respective model chemical compound is of the desired classification modeled by the n-1 SAR model, i.e., the n-1 SAR model predicts the classification of the respective model chemical compound (block 250). As such, the predicted classification of the respective (i.e., removed) model chemical compound may be compared to the known classification of the respective model chemical compound to determine whether the SAR model to be validated accurately predicts a correct classification (block 252).

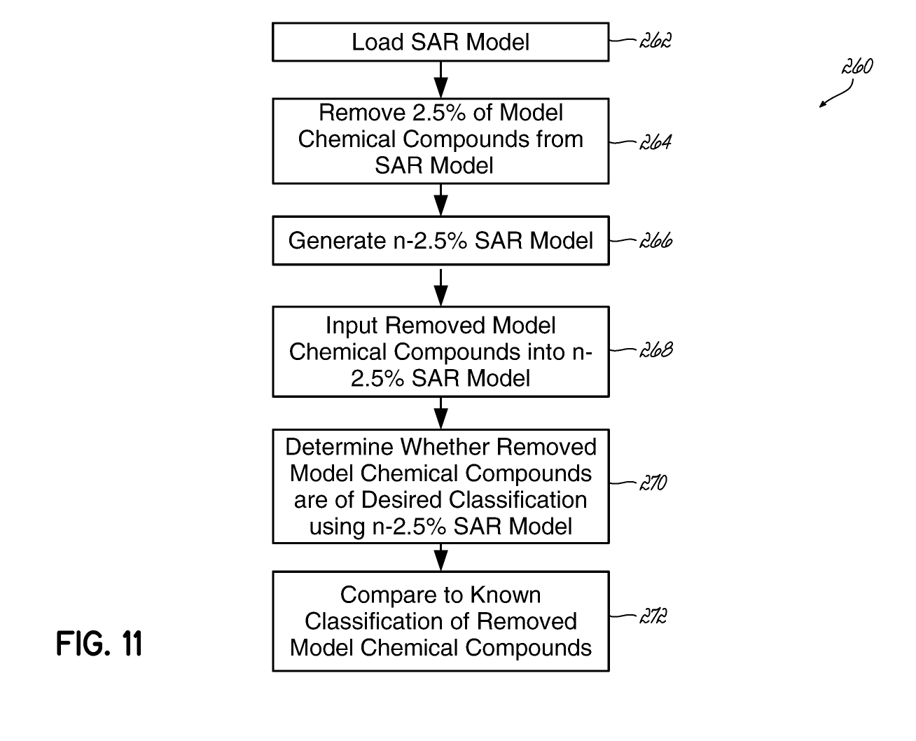

Moreover, in some embodiments, a leave-many-out (LMO) validation may be conducted where, for example 10,000 randomly selected sets of, for example, 2.5% of the model chemical compounds may be removed from the plurality, and a n-2.5% SAR model may be derived. Referring to FIG. 11, which provides flowchart 260, which provides a sequence of operations that may be performed by a computer generating a SAR model to perform a LMO validation. The computer loads the SAR model to be validated (block 262). The computer removes 2.5% of the model chemical compounds from the learning set of the SAR model to be validated (block 264). The computer generates a SAR model without the removed model chemical compounds in the learning set, i.e., the computer generates an n-2.5% SAR model (block 266). The removed model chemical compounds are input into the n-2.5% SAR model (block 268). The n-2.5% SAR model predicts a classification of the removed model chemical compounds (block 270). The predicted classifications may be compared to the known classifications of the removed model chemical compounds to determine whether the SAR model accurately predicts the correct classifications (block 272). Hence, in these embodiments, the classification of each of the removed model chemical compounds may be predicted using the n-2.5% SAR model and the average sensitivity, specificity, and concordance may be calculated. While flowchart 260 illustrates removing an exemplary 2.5% of the model chemical compounds in 10,000 randomly selected sets, the invention is not so limited. As such, embodiments consistent with the invention may perform a LMO validation by subtracting any percentage of model chemical compounds in practically any number of randomly selected sets. For example, in one exemplary embodiment, 5,000 random sets of 10% of model chemical compounds may be removed; in a second exemplary embodiment 100 random sets of 1% of model chemical compounds may be removed; or practically any other combination. As such, the removed sets may comprise any percentage of the learning set in any number of random sets.

In some embodiments, an external validation may be performed on a generated SAR model. In these embodiments, random sets of a desired percentage of the model chemical compounds may be removed, and a SAR model may be generated using the remaining model chemical compounds of the learning set, while predictions close to the activity threshold for the model may be excluded from the final assessment of the SAR model. For example, 10 random sets of 10% of model chemical compounds may be removed with the remaining 90% of the model chemical compounds used to generate a SAR model and determine the classification of those model chemical compounds removed and the average sensitivity, specificity, and concordance values may be calculated, while predictions close to the activity threshold for the model may be excluded from the final assessment of the SAR model.

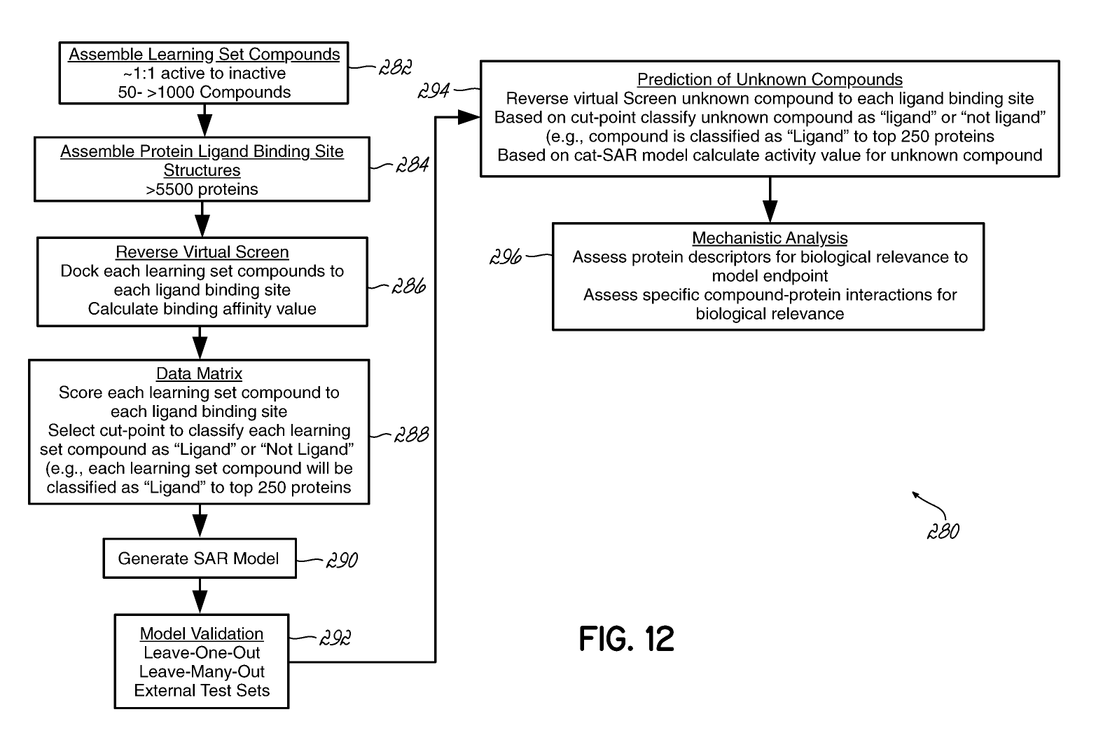

FIG. 12 is a flowchart illustrating a sequence of operations that may be performed by a computer to generate a SAR model including a plurality of model chemical compounds and a plurality of ligand descriptors associated with each model chemical compound; validate the generated SAR model; and predict a classification/property of a test chemical compound using the generated SAR model. A computer generating a SAR model consistent with embodiments of the invention assembles a learning set of chemical compounds (i.e., a plurality of model chemical compounds) (block 282). In some embodiments, the computer may access one or more databases including information associated with chemical compounds, and the computer may analyze the databases to select chemical compounds to be model chemical compounds for the SAR model. For example, a SAR model configured to determine if a test chemical compound were carcinogenic would include a learning set comprising model chemical compounds classified as carcinogenic and model chemical compounds classified as non-carcinogenic. As such, in this example the computer generating the SAR model would analyze the database to identify carcinogenic and non-carcinogenic chemical compounds to include in the learning set as model chemical compounds.

The computer assembles protein ligand binding sites (block 284). In some embodiments, the computer may access one or more databases to determine proteins to be included in the protein ligand binding site structures used to generate the SAR model. The computer virtually screens the model chemical compounds of the learning set to the protein binding site structures to estimate affinity values for each model chemical compound to each protein binding site structure (block 286). The computer generates a model chemical compound-ligand matrix including the estimated affinity values for each model chemical compound to each protein binding site structure, and the computer analyzes the matrix to determine ligand descriptors to associate with each model chemical compound (block 288). Based on the determined ligand descriptors and the model chemical compounds of the learning set, the computer generates the computer based SAR model (block 290).

The computer may validate the generated SAR model by performing a LOO validation, LMO validation, and/or external validation (block 292). If the SAR model meets specificity, sensitivity, and or concordance requirements, the computer may execute the SAR model to predict the classification of an unknown chemical compound (i.e., a test chemical compound). The computer executing the SAR model virtually screens the test chemical compound to the protein ligand binding site structures to estimate affinity values for the test chemical compound with each protein binding site structure, and the computer associates ligand descriptors to the test chemical compound based on the estimated affinity values (block 294). The computer determines whether the test chemical compound is of the desired classification based on the ligand descriptors and the biological relevance of the ligand descriptors to the ligand descriptors associated with the model chemical compounds (block 296).

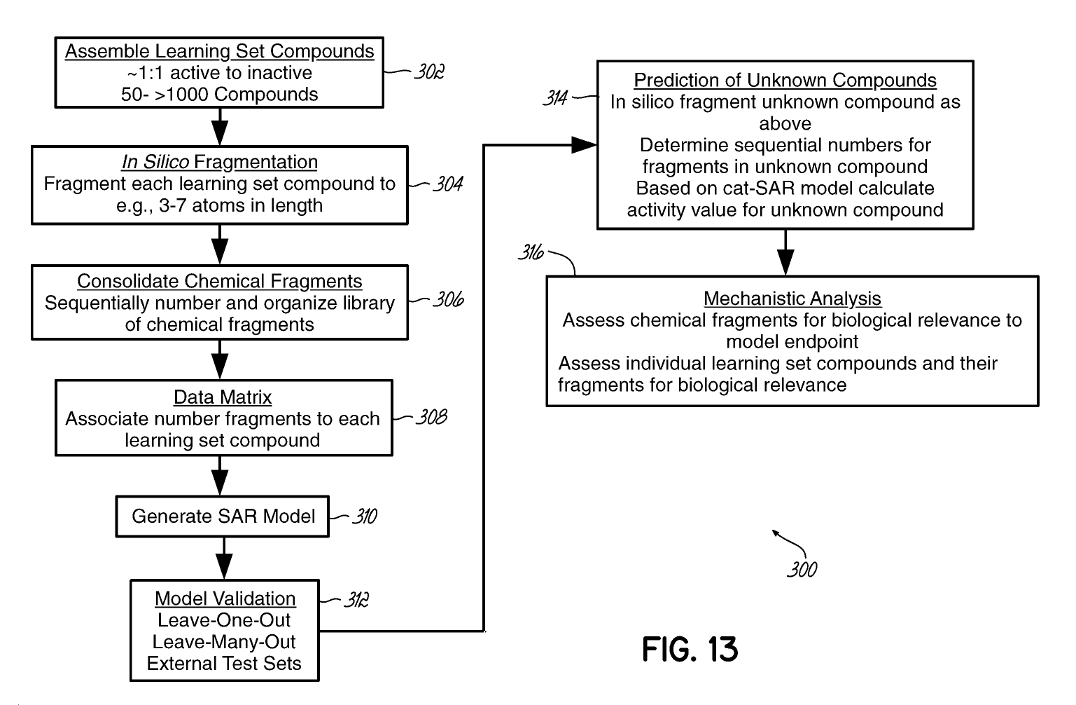

FIG. 13 is a flowchart illustrating a sequence of operations that may be performed by a computer to generate a SAR model including a plurality of model chemical compounds (i.e., a learning set), and a plurality of fragment descriptors associated with each model chemical compound; to validate the generated SAR model; and to determine a classification of an unknown chemical compound (i.e., a test chemical compound) using the generated SAR model.

A computer generating a SAR model assembles a learning set of chemical compounds (i.e., a plurality of chemical compounds) (block 302). The computer fragments each model chemical compound into a plurality of chemical fragments (block 304). The computer sequentially numbers all the chemical fragments of the model chemical compounds and organizes the chemical fragments (block 306). The computer generates a model chemical compound-chemical fragment matrix (block 308), where the matrix may be analyzed to determine fragment descriptors associated with each model chemical compound. The computer generates a SAR model based at least in part on the model chemical compounds and the fragment descriptors associated with each model chemical compound (block 310).

The computer may validate the generated SAR model by performing a LOO validation, a LMO validation, and/or an external test validation (block 312). A computer executing the SAR model receives data indicating an unknown chemical compound (i.e., a test chemical compound), and the SAR model fragments the test chemical compound into a plurality of chemical fragments. The SAR model associates a plurality of fragment descriptors with the test chemical compound based at least in part on the chemical fragments (block 314). The SAR model analyzes the chemical fragments of the test chemical compound using the chemical fragments associated with the model chemical compounds to determine whether the test chemical compound is of the desired classification (block 316).

One area of particular difficulty in the classification of unknown/unclassified chemical compounds is determining whether or not a non-genotoxic chemical will be carcinogenic by means other than cancer bioassays, in large part because the cancer bioassays require significant resources and time to complete. The Ames Salmonella mutagenicity assay and other short-term tests for genotoxicity may be used to detect some carcinogens. These short-term genotoxicity tests only identify carcinogens that are genotoxic. However, a significant number of cancer causing (carcinogenic) chemical compounds are non-genotoxic, and do not directly interact with DNA but rather may induce cancer by alternative mechanisms. Hence, a classification on the Ames assay as non-genotoxic does not rule out the possibility that the chemical compound is a carcinogen, for which conventional methods and systems fail to classify.

As such, some embodiments of the invention may work in conjunction with a short-term assay, including, for example the Ames assay, to identify non-genotoxic carcinogens from among test chemical compounds that are indicated as non-genotoxic by the short term assay. Moreover, in some embodiments, the computer based SAR may dynamically select a model from a plurality of models included in the SAR model to determine whether a test chemical compound is of a desired classification based at least in part on the results of one of the short-term assays. Furthermore, while short-term assays such as the Ames assay may be useful for determining that a test chemical compound is genotoxic, the rapid throughput of a computer based SAR model of the present invention provides a distinct advantage for the classifying a large amount of test chemical compounds. Moreover, in some embodiments a SAR model consistent with the invention may be utilized to model the Ames assay, where the SAR model may include a model configured to determine whether a test chemical compound is genotoxic (e.g., the model may be configured to model the Ames assay), and the SAR model may selectively execute an included hybrid model, ligand model, and/or fragment model to determine whether the test chemical compound is of another desired classification (e.g., carcinogenic, targeting to a specific site/organ, and/or other such classifications).

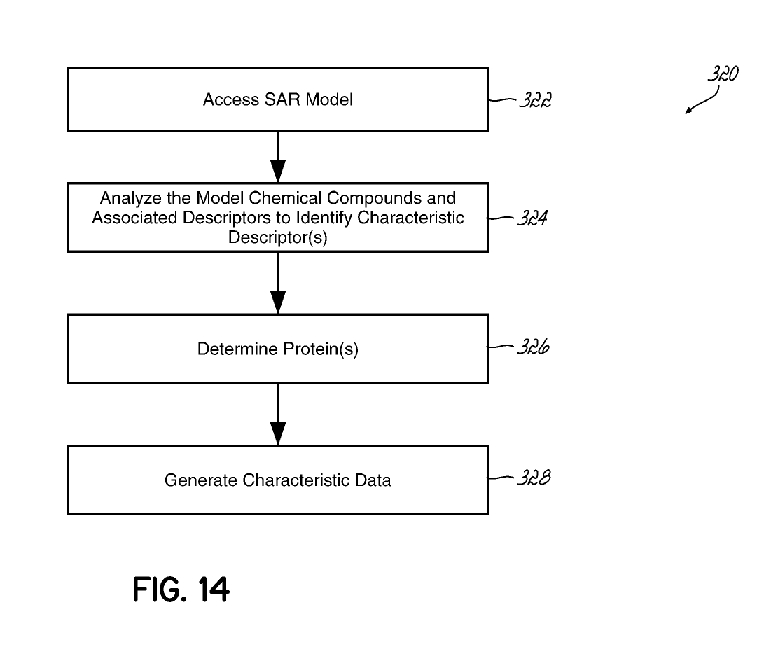

While a computer based SAR model consistent with embodiments of the invention may be used to determine whether unknown chemical compounds are of a desired classification, in some embodiments, a computer based SAR model consistent with embodiments of the invention may also be utilized to determine one or more characteristics of the desired classification which the SAR model is configured to model. For example, in some embodiments, a SAR model including a learning set of model chemical compounds and a plurality of ligand descriptors associated with each model chemical compound may be analyzed to generate characteristic data based at least in part on the ligand descriptors and the model chemical compounds. Referring to FIG. 14, which provides flowchart 320, which illustrates a sequence of operations that may be performed by a computer to analyze a SAR model to generate characteristic data corresponding to the desired classification the SAR model is configured to model. A computer accesses a SAR model for analysis (block 322), where the SAR model includes a plurality of model chemical compounds of a desired classification and a plurality of model chemical compounds not of the desired classification, and the SAR model further includes a plurality of ligand and/or fragment descriptors associated with the model chemical compounds. The computer analyzes the model chemical compounds and the associated descriptors to identify characteristic descriptors (block 324). In these embodiments, the computer analyzes the fragment and/or ligand descriptors to identify one or more descriptors that are associated with multiple model chemical compounds of the desired classification. As such, the computer analyzes the SAR model to identify descriptors common to model chemical compounds of the desired classification, the computer identifies the common descriptors as characteristic descriptors, where the characteristic descriptors may indicate particular biological activity characteristics that may be linked to the desired classification. In some embodiments, the characteristic descriptors may include characteristic ligand descriptors, and the computer may determine a protein associated with each characteristic ligand descriptor (block 326). In some embodiments, the computer may identify characteristic descriptors based at least in part on the model chemical compounds not of the desired classification. As such, in these embodiments, a respective descriptor may be determined to not be a characteristic descriptor because the respective descriptor is also associated with model chemical compounds not of the desired classification, which may indicate that the respective descriptor is not related to a characteristic of the desired classification. The computer generates characteristic data based at least in part on the characteristic descriptors and/or determined proteins (block 328). The characteristic data indicates one or more determined mechanisms of biological activity associated with a desired classification, one or more characteristic descriptors, and/or one or more determined proteins associated with the desired classification.

For example, if a SAR model were configured to classify compounds as carcinogenic, the SAR model may include a plurality of model chemical compounds classified a carcinogenic and a plurality of model chemical compounds classified as non-carcinogenic, and the SAR model may further include a plurality of ligand descriptors associated with each model chemical compound. As such, the computer may analyze the carcinogenic model chemical compounds to identify one or more ligand descriptors associated with multiple carcinogenic compounds as characteristic ligand descriptors. Moreover, in some embodiments, the computer may identify a ligand descriptor as not a characteristic ligand descriptor if the ligand descriptor is also associated with one or more model chemical compounds not of the classification. The computer may identify a protein associated with each characteristic ligand descriptor, where the associated protein may relate to carcinogenicity. As such, the computer may generate characteristic data which indicates biological activity characteristics of carcinogenicity, where the data may indicate the characteristic ligand descriptors, the associated proteins, or other such similar information. The characteristic data may be output in a format executable by the computer, in a format readable by an operator of the computer, etc. As those skilled in the art will recognize, the characteristic data generated from analyzing a SAR model consistent with embodiments of the invention may be invaluable in determining factors involved in causing disease, causing cancer, treating disease, treating cancer, and other such purposes, where the characteristic data may identify common properties among the model chemical compounds of a desired classification that may be used as discussed.

Exemplary Structure Based Activity Relationship Models And Results.

To compare performance of SAR models consistent with some embodiments of the invention, an exemplary model was generated. A SAR model was generated to determine whether a test chemical compound is a mammary carcinogen. The first SAR model included a plurality of model chemical compounds classified as mammary carcinogens and a plurality of model chemical compounds classified as non-carcinogens, which may be referred to as the hybrid MC-NC model. The hybrid MC-NC model included a plurality of ligand descriptors and a plurality of fragment descriptors associated with the model chemical compounds included in the hybrid MC-NC model, where the hybrid MC-NC model includes a ligand model and a fragment model.

Leave-one-out (LOO) validation of the fragment model returned a concordance of 75%, a sensitivity of 69%, and specificity of 81% and the ligand model returned a concordance of 67% with a sensitivity of 69% and a specificity of 64% (Table 1). The fragment model made predictions on 182 out of the 208 chemical compounds (88%) and was based on 1583 significant fragments (724 active and 859 inactive). The ligand model made predictions on all 208 chemicals (100%) and was based on 835 proteins (216 active and 619 inactive). Through adjustment of various thresholds requirements in the hybrid MC-NC model, the hybrid MC-NC model returned a concordance of 79%, a sensitivity of 72%, and a specificity of 86%.

Thus differences exist between the classes of chemical compounds, where such classification may affect the predictive value of the two dimensional chemical structure and/or ligand binding site affinity. Since a fragment model and ligand model are both predictive and derive from different perspectives, the models may reflect different attributes of the model chemical compounds as well as different facets of the toxicological phenomena under study. Therefore, a computer based SAR model including a hybrid model, which in turn includes a ligand model and a fragment model may improve classification accuracy.

Provided below are some experimental results classifying a test chemical compound using a computer executing a SAR model consistent with embodiments of the invention.

PhIP-PhIP (2-amino-1-methyl-6-phenylimidazo[4,5-b]pyridine) has been demonstrated to be a genotoxic carcinogen and an estrogen receptor ligand and is reported in the CPDB as a Salmonella mutagen and mammary carcinogen. The International Agency for Research on Cancer (IARC) indicates that there is inadequate evidence to determine its carcinogenicity in humans and antiquated evidence for carcinogenicity in experimental animals. A fragment model analysis of rat mammary carcinogens observed that structural fragments were able to accurately classify PhIP as a mammary carcinogen, and some of the fragments that were used for this classification were related to genotoxicity and other fragments, while being related to carcinogenicity, were not apparently related to genotoxicity. In other words, this latter set of fragments suggested a non-genotoxic mechanism to PhIP's carcinogenic potential. With reference to table 200 provided below, analysis of PhIP by executing the ligand model determined that PhIP was accurately predicted during the LOO validation to be a mammary carcinogen rather than a non-carcinogen due to its potential interaction with 60 proteins, as indicated in table 1 (e.g., the activity value=0.64, cutoff value=0.61). Interestingly, of the 60 proteins identified several were related to “estrogenicity” including estrogen sulfotransferase PDB (Protein Data Bank) (PDB 1HY3), estrogen receptor alpha (PDB 1X7E), and estrogen receptor beta (PDB 1X78).

TABLE 1
SAR model prediction classifying PhIP as a mammary carcinogen based on leave-
one-out validation of the mammary carcinogen - non-carcinogen model (MC-NC).

| AR ID | PDBID | PDB name | #Act | # Inact | Total |
|---|---|---|---|---|---|
| pdb85 | 1akb | Aspartate aminotransferase | 35 | 22 | 57 |
| pdb271 | 1c1v | Thrombin | 5 | 3 | 8 |
| pdb307 | 1c8k | Glycogen phosphorylase | 11 | 5 | 16 |
| pdb503 | 1e0j | DNA primase/helicase | 21 | 11 | 32 |
| pdb529 | 1e66 | Acetylcholinesterase | 25 | 12 | 37 |
| pdb581 | 1efh | Bile salt sulfotransferase | 23 | 15 | 38 |
| pdb602 | 1ek6 | UDP-glucose 4-epimerase | 10 | 6 | 16 |
| pdb736 | 1fkw | Adenosine deaminase | 20 | 13 | 33 |
| pdb759 | 1frp | Fructose-1,6-bisphosphatase 1 | 12 | 6 | 18 |
| pdb876 | 1gha | Chymotrypsinogen A | 0 | 2 | 2 |
| pdb903 | 1gkd | Matrix metalloproteinase-9 | 4 | 1 | 5 |
| pdb996 | 1h1i | Quercetin 2,3-dioxygenase | 22 | 9 | 31 |
| pdb997 | 1h1m | Quercetin 2,3-dioxygenase | 21 | 13 | 34 |
| pdb1027 | 1h69 | NAD(P)H dehydrogenase [quinone] 1 | 28 | 18 | 46 |
| pdb1072 | 1hk1 | Serum albumin | 6 | 2 | 8 |
| pdb1146 | 1hy3 | ESTROGEN SULFOTRANSFERASE | 23 | 13 | 36 |
| pdb1166 | 1i2l | Aminodeoxychorismate lyase | 13 | 8 | 21 |
| pdb1348 | 1j7u | Aminoglycoside 3′-phosphotransferase | 5 | 3 | 8 |
| pdb1354 | 1j9z | NADPH--cytochrome P450 reductase | 2 | 9 | 11 |
| pdb1638 | 1l0o | Anti-sigma F factor | 16 | 8 | 24 |
| pdb1884 | 1mrq | Aldo-keto reductase | 8 | 3 | 11 |
| pdb1893 | 1mt6 | Histone-lysine N-methyltransferase*** | 4 | 0 | 4 |
| pdb1967 | 1nb6 | hepatitis C virus RNA polymerase | 6 | 1 | 7 |
| pdb2079 | 1nw5 | Modification methylase RsrI | 5 | 0 | 5 |
| pdb2285 | 1owb | Citrate synthase | 3 | 2 | 5 |
| pdb2553 | 1qg2 | GTP-binding nuclear protein Ran | 11 | 6 | 17 |
| pdb2587 | 1qkq | Eosinophil lysophospholipase | 6 | 1 | 7 |
| pdb2885 | 1sg6 | Pentafunctional AROM polypeptide | 25 | 13 | 38 |
| pdb2932 | 1sst | Serine acetyltransferase | 6 | 3 | 9 |
| pdb2976 | 1t41 | Aldose reductase | 5 | 3 | 8 |
| pdb3003 | 1t7q | Carnitine O-acetyltransferase | 4 | 1 | 5 |
| pdb3158 | 1u3w | Alcohol dehydrogenase | 3 | 2 | 5 |
| pdb3221 | 1uio | Adenosine deaminase | 11 | 2 | 13 |
| pdb3231 | 1ukt | Cyclomaltodextrin glucanotransferase | 0 | 3 | 3 |
| pdb3276 | 1ut6 | Acetylcholinesterase | 1 | 5 | 6 |
| pdb3356 | 1v6i | Galactose-binding lectin | 13 | 7 | 20 |
| pdb3380 | 1vbe | poliovirus 3 RNA-dependent RNA polymerase | 7 | 4 | 11 |
| pdb3482 | 1w22 | Histone deacetylase 8 | 9 | 3 | 12 |
| pdb3658 | 1x78 | Estrogen receptor beta | 2 | 0 | 2 |
| pdb3659 | 1x7a | Coagulation factor IX | 4 | 1 | 5 |
| pdb3661 | 1x7e | Estrogen receptor alpha | 5 | 0 | 5 |
| pdb3664 | 1x82 | Glucose-6-phosphate isomerase | 4 | 1 | 5 |
| pdb3715 | 1xic | Xylose isomerase | 28 | 14 | 42 |
| pdb3768 | 1xp8 | Protein recA | 2 | 1 | 3 |
| pdb3777 | 1xqp | N-glycosylase/DNA lyase | 26 | 15 | 41 |
| pdb3798 | 1xv5 | DNA alpha-glucosyltransferase | 26 | 17 | 43 |
| pdb4031 | 1z95 | Putative uncharacterized protein | 19 | 6 | 25 |
| pdb4484 | 2c9d | 6,7-dimethyl-8-ribityllumazine synthase | 1 | 5 | 6 |
| pdb4514 | 2clx | Cell division protein kinase 2 | 21 | 13 | 34 |
| pdb4578 | 2dt5 | Redox-sensing transcriptional repressor rex | 20 | 8 | 28 |
| pdb4647 | 2f6t | Tyrosine-protein phosphatase non-receptor type 1 | 3 | 1 | 4 |
| pdb4673 | 2fdd | HIV integrase | 24 | 8 | 32 |
| pdb4740 | 2g6b | Ras-related protein Rab-26 | 0 | 6 | 6 |
| pdb5039 | 2izz | Pyrroline-5-carboxylate reductase | 4 | 2 | 6 |
| pdb5086 | 2j9h | Glutathione S-transferase | 21 | 13 | 34 |
| pdb5176 | 2o1x | 1-deoxy-D-xylulose-5-phosphate synthase | 8 | 5 | 13 |
| pdb5202 | 2ob2 | Leucine carboxyl methyltransferase 1 | 11 | 7 | 18 |
| pdb5315 | 2qwc | Neuraminidase | 11 | 5 | 16 |
| pdb5346 | 2uue | Cell division protein kinase 2 | 2 | 10 | 12 |
| pdb5442 | 4rhn | Histidine triad nucleotide-binding protein 1 | 15 | 6 | 21 |

Average Summary for PHIP: cutoff value-0.61

| Activity | Mean % act | Mean % inact | count |
|---|---|---|---|
| 1 | 0.635 | 0.365 | 60 |

Atrazine-Atrazine, a triazine herbicide, is reported in the CPDB as a Salmonella non-mutagen, and rat mammary carcinogen. IARC indicates that while there is adequate evidence of carcinogenicity in experimental animals there is inadequate evidence to determine its carcinogenicity in humans. Referring to table 2, provided below, and considering the LOO validation, atrazine was correctly predicted to be a rat mammary carcinogen by the ligand model (activity value=0.66, cutoff value=0.61). Of the 79 PDB structures used for the MC-NC prediction for mammary carcinogenicity, an automated Medline search identified six proteins that had references to both breast cancer and atrazine. These included aspartate aminotransferase (PDB 1AKA, 1ARG, 1CQ8), L-lactate dehydrogenase (PDB 1LLD), glycogen phosphorylase (PDB 1P4G), chitinase (PDB 1W1T), chloramphenicol aminotransferase 3 (PDB 1CLA), and glutathione S-transferase (PDB 4GST).

TABLE 2
SAR model prediction classifying atrazine as a mammary carcinogen based on leave-
one-out validation of the mammary carcinogen - non-carcinogen model (MC-NC).

| SAR ID | PDBID | PDB name | #Act | # Inact | Total |
|---|---|---|---|---|---|
| pdb84 | 1aka | ASPARTATE AMINOTRANSFERASE | 32 | 14 | 46 |
| pdb113 | 1arg | ASPARTATE AMINOTRANSFERASE | 42 | 21 | 63 |
| pdb139 | 1b1c | NADPH--cytochrome P450 reductase | 16 | 4 | 20 |
| pdb241 | 1bvy | Bifunctional P-450: NADPH-P450 reductase | 29 | 8 | 37 |
| pdb357 | 1cq8 | ASPARTATE AMINOTRANSFERASE | 29 | 19 | 48 |
| pdb482 | 1ddt | HIV-1 reverse transcriptase | 6 | 1 | 7 |
| pdb578 | 1eet | HIV-1 REVERSE TRANSCRIPTASE | 1 | 5 | 6 |
| pdb733 | 1fk9 | HIV-1 reverse transcriptase | 15 | 8 | 23 |
| pdb822 | 1g4t | Thiamine-phosphate pyrophosphorylase | 22 | 9 | 31 |
| pdb839 | 1g7g | Tyrosine-protein phosphatase non-receptor type 1 | 12 | 7 | 19 |
| pdb912 | 1gnq | C-H-RAS P21 PROTEIN | 10 | 6 | 16 |
| pdb923 | 1gpu | TRANSKETOLASE | 5 | 2 | 7 |
| pdb997 | 1h1m | QUERCETIN 2,3-DIOXYGENASE | 21 | 13 | 34 |
| pdb1089 | 1ho4 | PYRIDOXINE 5′-PHOSPHATE SYNTHASE | 6 | 4 | 10 |
| pdb1114 | 1hsl | HISTIDINE-BINDING PROTEIN | 16 | 10 | 26 |
| pdb1188 | 1i7l | Synapsin-2 | 9 | 6 | 15 |
| pdb1253 | 1ikx | HIV reverse transcriptase | 11 | 5 | 16 |
| pdb1296 | 1itz | TRANSKETOLASE | 9 | 5 | 14 |
| pdb1548 | 1ki7 | THYMIDINE KINASE | 16 | 7 | 23 |
| pdb1552 | 1kij | Gyrase B | 4 | 2 | 6 |
| pdb1568 | 1knr | L-aspartate oxidase | 33 | 22 | 55 |
| pdb1645 | 1l3l | LuxR-type protein | 11 | 7 | 18 |
| pdb1710 | 1lld | L-lactate dehydrogenase) | 0 | 2 | 2 |
| pdb1724 | 1lox | Arachidonate 15-lipoxygenase | 14 | 7 | 21 |
| pdb1776 | 1m2k | NAD-dependent deacetylase | 10 | 6 | 16 |
| pdb1967 | 1nb6 | hepatitis C virus RNA polymerase | 6 | 1 | 7 |
| pdb1970 | 1nc1 | MTA/SAH nucleosidase | 3 | 13 | 16 |
| pdb2084 | 1nwl | Tyrosine-protein phosphatase non-receptor type 1 | 3 | 1 | 4 |
| pdb2280 | 1ove | Mitogen-activated protein kinase 14 | 2 | 0 | 2 |
| pdb2324 | 1p4g | Glycogen phosphorylase | 4 | 1 | 5 |
| pdb2556 | 1qgd | Transketolase 1 | 2 | 0 | 2 |
| pdb2576 | 1qjx | Human rhinovirus 16 coat protein | 18 | 9 | 27 |
| pdb2577 | 1qjy | Human rhinovirus 16 coat protein | 15 | 7 | 22 |
| pdb2684 | 1r7u | Histo-blood group ABO system transferase | 4 | 1 | 5 |
| pdb2691 | 1ra2 | Dihydrofolate reductase | 6 | 3 | 9 |
| pdb2836 | 1s3u | Dihydrofolate reductase | 2 | 0 | 2 |
| pdb2903 | 1sm8 | Deoxyuridine 5′-triphosphate nucleotidohydrolase | 3 | 2 | 5 |
| pdb2956 | 1szm | cAMP-dependent protein kinase | 29 | 19 | 48 |
| pdb2988 | 1t5b | FMN-dependent NADH-azoreductase | 20 | 6 | 26 |
| pdb3019 | 1tbm | phosphodiesterase 9 | 1 | 6 | 7 |
| pdb3045 | 1til | Anti-sigma F factor | 9 | 4 | 13 |
| pdb3084 | 1tq2 | Interferon-inducible GTPase 1 | 30 | 20 | 50 |
| pdb3147 | 1u2g | NAD(P) transhydrogenase | 10 | 3 | 13 |
| pdb3278 | 1uu3 | PkB-like | 28 | 16 | 44 |
| pdb3303 | 1uy9 | HSP90AA1 protein | 15 | 10 | 25 |
| pdb3348 | 1v3t | NADP-dependent leukotriene B4*** | 8 | 5 | 13 |
| pdb3369 | 1v9o | nitrogen regulatory protein | 9 | 1 | 10 |
| pdb3428 | 1vjj | Protein-glutamine gamma-glutamyltransferase E | 9 | 4 | 13 |
| pdb3460 | 1vzc | Thymidylate synthase | 3 | 1 | 4 |
| pdb3479 | 1w1t | Chitinase | 8 | 3 | 11 |
| pdb3481 | 1w1v | chitinase B | 3 | 0 | 3 |
| pdb3549 | 1wbe | Glycolipid transfer protein | 6 | 2 | 8 |
| pdb3743 | 1xm6 | cAMP-specific 3′,5′-cyclic phosphodiesterase 4B | 5 | 2 | 7 |
| pdb3755 | 1xoe | Neuraminidase | 2 | 0 | 2 |
| pdb3762 | 1xov | Ply protein | 7 | 1 | 8 |
| pdb3961 | 1yxv | Proto-oncogene serine/threonine-protein kinase Pim-1 | 6 | 3 | 9 |
| pdb4002 | 1z4j | 5′(3′)-deoxyribonucleotidase | 14 | 9 | 23 |
| pdb4003 | 1z4k | 5′(3′)-deoxyribonucleotidase | 18 | 12 | 30 |
| pdb4004 | 1z4l | 5′(3′)-deoxyribonucleotidase | 20 | 8 | 28 |
| pdb4009 | 1z4z | Hemagglutinin-neuraminidase | 23 | 14 | 37 |
| pdb4295 | 2b9i | Mitogen-activated protein kinase FUS3 | 5 | 3 | 8 |
| pdb4469 | 2c69 | Cell division protein kinase 2 | 7 | 2 | 9 |
| pdb4470 | 2c6e | Serine/threonine-protein kinase 6 | 5 | 3 | 8 |
| pdb4474 | 2c6m | Cell division protein kinase 2 | 1 | 4 | 5 |
| pdb4578 | 2dt5 | Redox-sensing transcriptional repressor rex | 20 | 8 | 28 |
| pdb4644 | 2f5t | Putative uncharacterized protein | 0 | 8 | 8 |
| pdb4650 | 2f6y | Tyrosine-protein phosphatase non-receptor type 1 | 6 | 1 | 7 |
| pdb4775 | 2gns | Phospholipase A2 | 2 | 0 | 2 |
| pdb4877 | 2hl0 | Threonyl-tRNA synthetase | 27 | 15 | 42 |
| pdb4887 | 2hoz | Glutamate-1-semialdehyde 2,1-aminomutase | 34 | 18 | 52 |
| pdb5039 | 2izz | Pyrroline-5-carboxylate reductase | 4 | 2 | 6 |
| pdb5067 | 2j75 | Beta-glucosidase | 3 | 1 | 4 |
| pdb5176 | 2o1x | 1-deoxy-D-xylulose-5-phosphate synthase | 8 | 5 | 13 |
| pdb5302 | 2p9e | D-3-phosphoglycerate dehydrogenase | 6 | 1 | 7 |
| pdb5338 | 2trt | Tetracycline repressor protein class D | 31 | 12 | 43 |
| pdb5370 | 2uy5 | Endochitinase | 2 | 1 | 3 |
| pdb5384 | 3cla | Chloramphenicol acetyltransferase 3 | 1 | 6 | 7 |
| pdb5433 | 4gst | Glutathione S-transferase | 2 | 8 | 10 |
| pdb5435 | 4lbd | Retinoic acid receptor gamma-2 | 5 | 1 | 6 |

Average Summary for ATRAZINE: cutoff value-0.61

| Activity | Mean % act | Mean % inact | count |
|---|---|---|---|
| 1 | 0.660 | 0.340 | 79 |

Given these brief examples of rat mammary carcinogens and the observation that some of the PDB structures used for their accurate assessment as a rat mammary carcinogen have already been shown to be associated with the agent in question and breast cancer, it is evident that a SAR model including a ligand model can be used to provide a degree of insight into biologically relevant descriptors of activity. In other words, if no mechanism-based explanation for the mammary carcinogenic activity of these agents had yet been discovered, the modeling process described herein would have pointed to some likely targets for the agent and its carcinogenic activity.

While various examples herein have described determining whether a test chemical compound is carcinogenic, DNA reactive, and/or targets specific organs/sites, those skilled in the art will recognize that the invention is not so limited. For example, SAR models consistent with embodiments of the invention may be configured to determine whether a test chemical compound is toxic, an endocrine destructor, allergen, developmentally toxic, and other such classifications. Moreover, in some embodiments, a test chemical may be input into a SAR model to determine whether the chemical is of a classification, including, for example cancer fighting, disease fighting, and other such beneficial classifications. As such, embodiments of the invention may be used in a wide variety of applications where it is desirable to classify chemical compounds. For example, a property of an unknown chemical compound may be predicted using a SAR model consistent with embodiments of the invention. As such, some embodiments of the invention may be utilized to select test chemical compounds from a plurality of test chemical compounds that are predicted to possess the desired property.

While the invention has been illustrated by a description of the various embodiments and the examples, and while these embodiments have been described in considerable detail, it is not the intention of the applicants to restrict or in any other way limit the scope of the appended claims to such detail. Additional advantages and modifications will readily appear to those skilled in the art. Thus, the invention in its broader aspects is therefore not limited to the specific details, representative apparatus and method, and illustrative example shown and described. In particular, any of the blocks of the above flowcharts may be deleted, augmented, made to be simultaneous with another, combined, or be otherwise altered in accordance with the principles of the invention. Accordingly, departures may be made from such details without departing from the spirit or scope of applicants' general inventive concept.

What is claimed is:

1. A method of generating a structure activity relationship model, comprising:
receiving data utilizing a computer, the computer including a processor and a memory, the data being associated with a plurality of model chemical compounds and a plurality of ligand descriptors associated with each model chemical compound of the plurality of model chemical compounds;
generating a computer based structure activity relationship model utilizing the processor, the computer based structure activity relationship model being based at least in part on the model chemical compounds and the plurality of ligand descriptors associated with each model chemical compound, such that the computer based structure activity model includes a plurality of model chemical compounds and a plurality of ligand descriptors associated with each model chemical compound, the computer based structure activity relationship model being configured to:
receive data associated with a test chemical compound, and
classify the test chemical compound based at least in part on the plurality of model chemical compounds and the plurality of ligand descriptors associated with each model chemical compound; and
storing the generated computer based structure activity relationship model in the memory.

2. The method of claim 1, wherein the received data further indicates a plurality of fragment descriptors associated with each model chemical compound,
wherein generating the computer based structure activity relationship model is based at least in part on the fragment descriptors associated with each model chemical compound of the plurality of model chemical compounds,
wherein the computer based structure activity relationship model includes a plurality of fragment descriptors associated with each model chemical compound, and
wherein the computer based structure activity relationship model is further configured to classify the test chemical compound based at least in part on the plurality of fragment descriptors associated with each model chemical compound.

3. The method of claim 2, further comprising:
analyzing the plurality of model chemical compounds to determine a plurality of fragment descriptors associated with each model chemical compound of the plurality of model chemical compounds.

4. The method of claim 1, further comprising:
analyzing the plurality of model chemical compounds to determine a plurality of ligand descriptors associated with each model chemical compound of the plurality of model chemical compounds.

5. The method of claim 4, wherein analyzing the plurality of model chemical compounds to determine a plurality of ligand descriptors associated with each model chemical compound of the plurality of chemical compounds includes:
virtually screening each model chemical compound against a plurality of ligand binding sites of a plurality of proteins, and
associating a respective ligand descriptor corresponding to a respective ligand binding site with a respective model chemical compound based at least in part on the virtual screening.

6. The method of claim 5, wherein virtually screening each model chemical compound against the plurality of ligand binding sites of the plurality of proteins includes estimating an affinity of each model chemical compound for each ligand binding site, and wherein a respective chemical compound is associated with a respective model ligand descriptor based at least in part on the estimated affinity of the respective chemical compound for the respective ligand binding site.

7. The method of claim 4, wherein analyzing the plurality of chemical compounds to determine a plurality of fragment descriptors associated with each chemical compound of the plurality of chemical compounds includes fragmenting each chemical compound into all possible fragments.

8. The method of claim 1, wherein the plurality of model chemical compounds includes a plurality of model chemical compounds of a desired classification and a plurality of model chemical compounds not of a desired classification,
wherein the computer based structure activity relationship model is configured to classify the test chemical compound based at least in part on the plurality of model chemical compounds and the plurality of ligand descriptors associated with each model chemical compound by determining whether a ligand descriptor of a plurality of ligand descriptors associated with the test chemical compound corresponds to any ligand descriptor associated with the plurality of model chemical compounds of the desired classification.

9. A method of classifying chemical compounds using structure activity relationship modeling, comprising modeling known chemical compounds based upon a combination of chemical structure using fragment descriptors and chemical compound-protein interactions using ligand descriptors.

10. A method of determining whether a test chemical compound is of a desired classification, the method comprising:
inputting a plurality of ligand descriptors associated with a test chemical compound into a computer based structure activity model, the computer based structure activity model including a plurality of ligand descriptors associated with a plurality of model chemical compounds of the desired classification; and
determining whether the test chemical compound is of the desired classification based at least in part on whether any of the plurality of ligand descriptors associated with the test chemical compound correspond to any of the plurality of ligand descriptors associated with the model chemical compounds of the desired classification.

11. The method of claim 10, further comprising:
analyzing the test chemical compound to determine a plurality of ligand descriptors associated with the test chemical compound.

12. The method of claim 10, wherein the computer based structure activity model includes a plurality of ligand descriptors associated with a plurality of model chemical compounds not of the desired classification, and
wherein determining whether the test chemical compound is of the desired classification is based at least in part on whether any of the plurality of ligand descriptors associated with the test chemical compound correspond to any of the plurality of ligand descriptors associated with the model chemical compounds not of the desired classification.

13. The method of claim 12, further comprising:
inputting a plurality of fragment descriptors associated with the test chemical compound into the computer based structure activity model, the computer based structure activity model including a plurality of fragment descriptors associated with the plurality of model chemical compounds of the desired classification, and
wherein determining whether the test chemical compound is of the desired classification is based at least in part on whether any of the plurality of fragment descriptors associated with the test chemical compound correspond to any of the plurality of fragment descriptors associated with the model chemical compounds of the desired classification.

14. The method of claim 13, wherein the computer based structure activity model includes a plurality of fragment descriptors associated with a plurality of model chemical compounds not of the desired classification, and
wherein determining whether the test chemical compound is of the desired classification is based at least in part on whether any of the plurality of fragment descriptors associated with the test chemical compound correspond to any of the plurality of fragment descriptors associated with the model chemical compounds not of the desired classification.

15. The method of claim 14, further comprising:
determining whether the test chemical compound is DNA reactive, and
wherein inputting a plurality of ligand descriptors associated with the test chemical compound into the computer based structure activity model is in response to determining that the test chemical compound is not DNA reactive.

16. The method of claim 15, wherein inputting a plurality of fragment descriptors associated with the test chemical compound into the computer based structure activity model is in response to determining that the test chemical compound is DNA reactive.

17. The method of claim 10, wherein the desired classification is carcinogenic.

18. An apparatus comprising:
a processor;
a memory; and
program code resident in the memory and configured to be executed by the processor to receive data associated with a plurality of model chemical compounds and a plurality of ligand descriptors associated with each model chemical compound of the plurality of model chemical compounds, cause the processor to generate a computer based structure activity relationship model based at least in part on the model chemical compounds and the plurality of ligand descriptors associated with each model chemical compound, such that the computer based structure activity model includes a plurality of model chemical compounds and a plurality of ligand descriptors associated with each model chemical compound, the computer based structure activity relationship model being configured to cause the processor to:
receive data associated with a test chemical compound, and
classify the test chemical compound based at least in part on the plurality of model chemical compounds and the plurality of ligand descriptors associated with each model chemical compound, and
the program code being further configured to cause the processor to store the generated computer based structure activity relationship model in the memory.

19. An apparatus comprising:
a processor;
a memory;
a computer based structure activity model stored in the memory and configured to be executed by the processor to:
cause the processor to receive a plurality of ligand descriptors associated with a test chemical compound into the computer based structure activity model, the computer based structure activity model including a plurality of ligand descriptors associated with a plurality of model chemical compounds of a desired classification, and
cause the processor to determine whether the test chemical compound is of the desired classification based at least in part on whether any of the plurality of ligand descriptors associated with the test chemical compound correspond to any of the plurality of ligand descriptors of the model chemical compounds of the desired classification.

20. A program product comprising:
a computer readable medium; and
a computer based structure activity relationship model resident on the computer readable medium, the computer based structure activity relationship model including data indicating a plurality of ligand descriptors associated with a plurality of model chemical compounds of a desired classification, the computer based structure activity relationship model being executable by a processor to cause the processor to:
receive data indicating a plurality of ligand descriptors associated with a test chemical compound, and
determine whether the test chemical compound is of the desired classification based at least in part on whether any of the plurality of ligand descriptors associated with the test chemical compound correspond to any of the plurality of ligand descriptors of the model chemical compounds of the desired classification.

21. A method of determining biological activity characteristics of a desired classification, the method comprising:
accessing a computer based structure activity relationship model stored in a memory of a computer, the computer based structure activity relationship model including data indicating a plurality of model chemical compounds of the desired classification and a plurality of model chemical compounds not of the desired classification, the data further indicating a plurality of ligand descriptors associated with each model chemical compound;
analyzing the computer based structure activity relationship model to identify at least one characteristic ligand descriptor associated with multiple model chemical compounds of the desired classification from the plurality of ligand descriptors;
analyzing the at least one characteristic ligand descriptor to determine at least one protein associated with the at least one characteristic ligand descriptor; and
generating characteristic data indicating biological activity characteristics of the desired classification based at based at least in part on the at least one protein.
